(19) United States
(12) Patent Application Publication
(10) Pub. No.: US 2026/0276917 A1
(43) Pub. Date: Sep. 17, 2026

(54) DETACHABLE CPO CONNECTOR AND ASSOCIATED METHODS

(71) Applicant: MELLANOX TECHNOLOGIES, LTD., Yokneam (IL)

(72) Inventors: Victor BIGIO, Ramat Gan (IL); Yaakov Yonatan LAYOSH, Ganei Modi’in (IL); Idan CHAYUN, Petah Tikva (IL); Amit OREN, Ramat Hasharon (IL); Barak FREEDMAN, Binyamina (IL); David ARBEL, Haifa (IL)

(73) Assignee: MELLANOX TECHNOLOGIES, LTD., Yokneam (IL)

(21) Appl. No.: 19/401,106

(22) Filed: Nov. 25, 2025

Related U.S. Application Data
(60) Provisional application No. 63/771,913, filed on Mar. 14, 2025.

(51) Int. Cl. G02B 6/42

(52) U.S. Cl. CPC G02B 6/4231

(57) ABSTRACT

Some embodiments of the present disclosure are directed to a detachable connector for a co-packaged optics (CPO) device. The detachable connector may include a kinematic mount, where the kinematic mount includes a first kinematic interface configured to engage a corresponding kinematic interface of the CPO device. In some embodiments, the kinematic mount is configured for repeated detachment and attachment with substantially identical alignment between the detachable connector and the CPO device within a predetermined sub-micron tolerance. Furthermore, in an attached state, the kinematic mount may be configured to provide an optical transmission path between the CPO device and the detachable connector, where a transmission loss along the optical transmission path remains within a predetermined threshold tolerance.

### CROSS-REFERENCE TO RELATED APPLICATION

The present application claims the benefit of U.S. Patent Application No. 63/771,913 for a “Detachable CPO Connector and Associated Methods” filed Mar. 14, 2025, which is hereby incorporated by reference in its entirety.

### TECHNOLOGICAL FIELD

The present disclosure is directed to detachable co-packaged optical (CPO) connectors and methods of using the same.

### BACKGROUND

With demand for high-speed and high-volume data communication increasing, communications providers are increasingly adopting optics-based communication solutions. To meet these demands, methods of improving the performance of optical elements are being developed.

### GENERAL DESCRIPTION

In one aspect, a detachable connector is presented. The detachable connector may include a kinematic mount, where the kinematic mount includes a first kinematic interface configured to engage a corresponding kinematic interface of a co-packaged optics (CPO) device. The kinematic mount may be configured for repeated detachment and attachment with substantially identical alignment between the detachable connector and the CPO device within a predetermined sub-micron tolerance. In an attached state, the kinematic mount may be configured to provide an optical transmission path between the CPO device and the detachable connector, where a transmission loss along the optical transmission path remains within a predetermined threshold tolerance.

In some aspects, the first kinematic interface includes a plurality of alignment spheres and the second kinematic interface includes a plurality of alignment grooves configured to, in the attached state, engage a corresponding alignment sphere of the plurality of alignment spheres.

In some aspects, the plurality of alignment grooves includes three alignment grooves and the plurality of alignment spheres includes three alignment spheres.

In some aspects, the kinematic mount further includes at least one rough alignment cavity configured to, in the attached state, receive at least one corresponding rough alignment element.

In some aspects, the at least one rough alignment cavity is configured to self-align with the at least one corresponding first rough alignment element by receiving the at least one corresponding rough alignment element via a first portion of the rough alignment cavity having a first diameter and allowing the at least one corresponding rough alignment element to slide along an inner surface of the rough alignment cavity toward a second portion of the rough alignment cavity, the second portion having a second diameter narrower than the first diameter.

In another aspect, a system is presented. The system may include a mounting element configured to be attached to a photonic integrated circuit (PIC), where the mounting element includes a planar body defining an optical window and a first kinematic interface supported by the planar body, the first kinematic interface including at least one first rough alignment element and a plurality of first fine alignment elements. The system may further include an attachment element configured to be attached to a fiber array unit (FAU), where the attachment element includes a second kinematic interface, the second kinematic interface including at least one second rough alignment element configured to engage the at least one first rough alignment element of the mounting element and a plurality of second fine alignment elements, where each second fine alignment element is configured to engage a corresponding first fine alignment element of the plurality of first fine alignment elements. In an instance in which the mounting element is attached to the PIC and the attachment element is attached to the FAU, the attachment element may be configured to be detachably coupled to the mounting element such that each fiber of the FAU is aligned with a corresponding optical aperture of the PIC.

In some aspects, at least one of the at least one first rough alignment element or the at least one second rough alignment element includes a column, and the other of the at least one first rough alignment element or the at least one second rough alignment element includes a cavity configured to receive the column.

In some aspects, one of the plurality of first fine alignment elements or the plurality of second fine alignment elements includes a sphere, and the other of the plurality of first fine alignment elements or the plurality of second fine alignment elements includes a groove configured to receive the sphere.

In some aspects, the groove includes a friction-reducing coating.

In some aspects, each second fine alignment element includes a sphere, and each first fine alignment element includes a groove configured to receive the sphere.

In some aspects, a bottom surface of the attachment element includes at least one concavity, and the sphere is adhered within the concavity to form the first fine alignment element.

In some aspects, a bottom surface of the attachment element includes at least one concavity, and the sphere is integrally formed within the concavity to form the first fine alignment element.

In some aspects, the attachment element includes three first fine alignment elements.

In some aspects, the first fine alignment elements are arranged on the attachment element in a triangular configuration.

In some aspects, the attachment element further includes a bonding surface configured to couple with a corresponding surface of the FAU, where the bonding surface is positioned at an angle with respect to the second kinematic interface.

In some aspects, the angle is a predetermined angle selected to minimize a working distance between an end of each fiber of the FAU and a corresponding optical aperture of the PIC.

In another aspect, a mounting element is presented. The mounting element may include a planar body defining an optical window and a first kinematic interface on a first surface of the planar body, the first kinematic interface comprising at least one rough alignment element and a plurality of fine alignment elements. A second surface of the planar body may be configured to be attached to a photonic integrated circuit (PIC). The first kinematic interface may be configured to be detachably coupled to a second kinematic interface of an attachment element, the attachment element being attached to a fiber array unit (FAU). In an instance in which the mounting element is attached to the PIC and the attachment element is attached to the FAU, the mounting element may be configured to be detachably coupled to the attachment element such that each fiber of the FAU is aligned with a corresponding optical aperture of the PIC.

In some aspects, the at least one rough alignment element includes a column extending from the first kinematic interface and configured to be engaged by a cavity of the second kinematic interface.

In some aspects, the at least one rough alignment element includes a cavity configured to receive a column extending from the second kinematic interface.

In some aspects, the plurality of fine alignment elements includes a groove configured to receive a sphere of the second kinematic interface.

In some aspects, the second kinematic interface includes a concavity, where the sphere is adhered within the concavity to form the fine alignment element.

In some aspects, the second kinematic interface includes a concavity, where the sphere is integrally formed within the concavity to form the fine alignment element.

In some aspects, the plurality of fine alignment elements includes three fine alignment elements.

In some aspects, the three fine alignment elements are arranged on the first kinematic interface in a triangular configuration.

In some aspects, the plurality of fine alignment elements includes a plurality of grooves, each groove being configured to receive a sphere of the second kinematic interface.

In some aspects, each groove includes a friction-reducing coating.

In another aspect, an attachment element is presented. The attachment element may include a first kinematic interface, the first kinematic interface including at least one rough alignment element and a plurality of fine alignment elements, where the attachment element is configured to be coupled to a fiber array unit (FAU). The first kinematic interface may be configured to be detachably coupled to a second kinematic interface of a mounting element, the mounting element being coupled to a photonics integrated circuit (PIC). In an instance in which the mounting element is attached to the PIC and the attachment element is attached to the FAU, the attachment element may be configured to be detachably coupled to the mounting element such that each fiber of the FAU is aligned with a corresponding optical aperture of the PIC.

In some aspects, the at least one rough alignment element includes a column configured to be engaged by a cavity of the mounting element.

In some aspects, the at least one rough alignment element includes a cavity configured to receive a column extending from the mounting element.

In some aspects, the plurality of fine alignment elements includes a plurality of spheres, each sphere being configured to be received by a groove of the mounting element.

In some aspects, the plurality of fine alignment elements includes a plurality of grooves, each groove being configured to receive a sphere of the mounting element.

In some aspects, each groove includes a friction-reducing coating.

In some aspects, the attachment element further includes a bonding surface configured to couple with a corresponding surface of the FAU, where the bonding surface is positioned at an angle with respect to the first kinematic interface.

In some aspects, the angle is a predetermined angle selected to minimize a working distance between an end of each fiber of the FAU and a corresponding optical aperture of the PIC.

In another aspect, a method of manufacturing a detachable connector for a co-packaged optics (CPO) device is presented. The method may include aligning a planar body of a mounting element with respect to a photonics integrated circuit (PIC), the mounting element comprising a first kinematic interface; aligning an optical window of the mounting element with respect to the PIC based on receiving feedback from one or more test fibers; bonding the mounting element to the PIC; aligning a fiber array unit (FAU) with respect to an attachment element, the attachment element including a second kinematic interface configured for repeated detachment and attachment with substantially identical alignment between the first kinematic interface and the second kinematic interface within a predetermined sub-micron tolerance, and bonding the FAU to the attachment element.

The features, functions, and advantages that have been discussed may be achieved independently in various embodiments of the present disclosure or may be combined with yet other embodiments, further details of which may be seen with reference to the following description and drawings.

### BRIEF DESCRIPTION OF THE DRAWINGS

Having thus described embodiments of the disclosure in general terms, reference will now be made to the accompanying drawings, wherein:

FIG. 1A illustrates a system for detachable coupling including an electronic module and a detachable connector in a detached state, in accordance with an embodiment of the disclosure;

FIG. 1B illustrates a system for detachable coupling including an electronic module and a detachable connector in an attached state, in accordance with an embodiment of the disclosure;

FIG. 2 illustrates a top plan view of an electronic module, in accordance with an embodiment of the disclosure;

FIG. 3 illustrates a perspective view of the electronic module of FIG. 2, in accordance with an embodiment of the disclosure;

FIG. 4A illustrates a top view of a mounting element for a detachable connector, in accordance with an embodiment of the disclosure;

FIG. 4B illustrates a perspective view of the mounting element of FIG. 4A, in accordance with an embodiment of the disclosure;

FIG. 5A is a perspective view from the top of a mounting element and an attachment element in a detached state, in accordance with an embodiment of the disclosure;

FIG. 5B is a perspective view from the bottom of a mounting element and an attachment element in a detached state, in accordance with an embodiment of the disclosure;

FIG. 5C is a bottom view of an attachment element, in accordance with an embodiment of the disclosure;

FIG. 6A illustrates a perspective view of a detachable connector of an optical device including an attachment element and a fiber array unit (FAU), in accordance with an embodiment of the disclosure;

FIG. 6B illustrates the FAU of the detachable connector of FIG. 6A, in accordance with an embodiment of the disclosure;

FIG. 6C illustrates a side view of the attachment element and a portion of the FAU of FIG. 6A, in accordance with an embodiment of the disclosure;

FIG. 6D illustrates a bottom view of the attachment element and a portion of the FAU of FIG. 6A, in accordance with an embodiment of the disclosure;

FIG. 6E illustrates a perspective view of an electronic module and a detachable connector in an attached state, in accordance with an embodiment of the disclosure;

FIG. 7A is a flowchart illustrating a method of assembling a detachable connector for detachably coupling an electronic module and an FAU, in accordance with an embodiment of the present disclosure;

FIG. 7B is a flowchart illustrating a method of detachably coupling an electronic module and an FAU, in accordance with an embodiment of the present disclosure;

FIG. 8A illustrates a detachable connector, in accordance with an embodiment of the present disclosure;

FIG. 8B illustrates a detachable connector, in accordance with an embodiment of the present disclosure;

FIG. 8C illustrates a connection portion of a detachable connector, in accordance with an embodiment of the present disclosure;

FIG. 8D illustrates a connection portion of a detachable connector including a polarization plate, in accordance with an embodiment of the present disclosure;

FIG. 8E illustrates a plurality of fibers of a detachable connector, in accordance with an embodiment of the present disclosure;

FIG. 8F illustrates a polarization plate, in accordance with embodiments of the present disclosure;

FIG. 9 illustrates an example network architecture, in accordance with an embodiment of the disclosure;

FIG. 10 illustrates an example datacenter network topology, in accordance with an embodiment of the disclosure;

FIG. 11 illustrates a co-packaged networking device, in accordance with an embodiment of the disclosure;

FIG. 12A is a flowchart illustrating a method for providing optical communications via a silicon photonics collimator, in accordance with an embodiment of the disclosure;

FIG. 12B is a flowchart illustrating an example method for providing optical communications via a silicon photonics collimator in accordance with an embodiment of the disclosure;

FIG. 12C illustrates a computing system, in accordance with an embodiment of the disclosure;

FIG. 13A illustrates a cross-sectional view of an optoelectronic component, in accordance with an embodiment of the disclosure;

FIG. 13B illustrates a top plan view of an optoelectronic component, in accordance with an embodiment of the disclosure;

FIG. 13C illustrates a portion of an optoelectronic component, in accordance with an embodiment of the disclosure; and

FIG. 13D illustrates a portion of an optoelectronic component, in accordance with an embodiment of the disclosure;

### DETAILED DESCRIPTION OF EMBODIMENTS

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Furthermore, when it is said herein that something is “based on” something else, it may be based on one or more other things as well. In other words, unless expressly indicated otherwise, as used herein “based on” means “based at least in part on” or “based at least partially on.” Also, as used herein, the term “or” is intended to be inclusive when used in a series and may be used interchangeably with “and/or,” unless explicitly stated otherwise (e.g., if used in combination with “either” or “only one of”). Like numbers refer to like elements throughout. No element, act, or instruction used herein should be construed as critical or essential unless explicitly described as such.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

Furthermore, as would be evident to one of ordinary skill in the art in light of the present disclosure, the terms “substantially” and “approximately” indicate that the referenced element or associated description is accurate to within applicable engineering tolerances.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, there are significant challenges to accurately align light signals on the SiP with an external device that transmits or receives the light, in particular a fiber array unit (FAU) with the silicon photonics chip which emits light from the top surface.

For instance, long range transmission of light signals is generally performed within optical fibers. When optical signals are generated or processed in a SiP device for transmission over optical fibers, the light needs to be propagated between the SiP device and the optical fibers. Coupling the SiP device and the optical fibers is challenging because the diameter of the waveguides within the SiP device are generally smaller than the diameter of the optical fibers. As such, a “world-to-chip” interface problem often arises in SiP technologies where coupling of light between Si wire waveguides and optical fibers, and vice versa, is generally inefficient. Furthermore, to increase coupling efficiency, it is also necessary to match the light modes between the optical fibers and the Si wire waveguides, which results in increased placement demands in free space optics.

Furthermore, during reflow processes involved in manufacturing SiP devices, optical fibers typically cannot be present on the SiP device due to the relatively high thermal sensitivity of the optical fibers. Specifically, the high temperatures applied to the SiP devices during reflow may degrade the optical fibers themselves, as well as degrade adhesives or epoxies used to attach the optical fibers to the SiP. Thus, it is preferable to removably attach optical fibers to a SiP device such that the optical fibers can be detached during a reflow process and reattached afterward using non-adhesive-based coupling techniques (e.g., using mechanical coupling techniques).

There is also a need to minimize the size, or footprint, of a SiP device in an optical system in order to increase the overall integration density of the optical system. Accordingly, the present disclosure provides relatively compact package with a decreased footprint that allows for integration into space-constrained devices, as well as increases the overall functionality per unit area of the system. Furthermore, the decreased footprint requires less material, as well as allows for more units to be produced per wafer or panel, which increases production efficiency and can lower cost. As such, it is preferable that the coupling between SiP devices and the optical fibers does not substantially increase the overall footprint of the SiP device. For example, a single photonic integrated circuit (PIC) may have a width of roughly 7 mm. Therefore, it is preferable that the width of the detachable coupling not exceed 7 mm (or preferably, not exceed 6.8 mm), such that multiple PICs may be positioned side-by-side in a system without the need to account for the additional width of a detachable coupling.

Furthermore, detachably connecting optical fibers is preferred for facilitating operative considerations, such as device replacement, maintenance, and servicing. Thus, the present disclosure provides a detachable mechanism that allows accurate positioning (location and mating) of the optical connector relative to an optical source with minimum tolerances. The detachable mechanism is capable to connect and disconnect to all CPO devices with a low power insertion loss of the light. A common connector is used across all packages. The assembly process of the connector ensures the optical performance. Specifically, the present disclosure is directed to the use of a kinematic mount (e.g., a deterministic mount, kinematic coupling, repeatable positioning mount, or the like) to removably couple and align an attachment element for a fiber array unit (FAU) to a mounting element in a highly precise and stable manner. The removable coupling and alignment is also highly repeatable, enabling the connector to be detached and reattached as needed (e.g., during a reflow process). The use of the kinematic mount of the present disclosure enables a high precision mechanical alignment, particularly significant for single-mode fiber optics requiring precise beam alignment in terms of angle and position relative to the photonic IC for good optical performance. In an example, the attachment element may be bonded to the FAU and the mounting element bonded to the PIC, with the kinematic mount providing the mechanical interface.

A kinematic mount, as contemplated herein, uses a defined set of contact points between mechanical components to constrain a certain number of degrees of freedom (DOF), while minimizing overall stress on the components. For example, in some embodiments, the kinematic mount includes three spherical contact points (e.g., a Maxwell kinematic mount, a three-sphere kinematic mount, or the like) between the attachment element and the mounting element, such that movement in all six DOF (X-translation, Y-translation, Z-translation, pitching, yawing, and rolling) is constrained. As described in greater detail below, embodiments of the present disclosure provide for a three-sphere kinematic mount, where each of the three spheres may be positioned within a corresponding groove (e.g., a V-shaped groove), such that each groove engages each sphere at two contact points, for a total of six contact points in the kinematic mount to achieve mechanical alignment and detachability.

Accordingly, the present disclosure includes a detachable connector for a co-packaged optics (CPO) device, the detachable connector including a kinematic mount mechanism. The kinematic mount mechanism may include a first kinematic interface configured to engage a corresponding kinematic interface of the CPO device, where the kinematic mount mechanism is configured for repeated detachment and attachment with substantially identical alignment between the detachable connector and the CPO device within a predetermined sub-micron tolerance. In an attached state, the kinematic mount mechanism may be further configured to provide an optical transmission path between the CPO device and the detachable connector, wherein a transmission loss along the optical transmission path remains within a predetermined threshold tolerance.

As described in greater detail below, the present disclosure is directed to mechanical connectors for detachably connecting FAUs to electronic modules such as SiP devices or the like. For example, a mechanical connector may be used to detachably connect an FAU to a PIC located on an SiP device, in order to allow propagation of light signals between the SiP device and the optical fibers of the FAU. A mechanical connector may include an FAU and an attachment element affixed to the FAU. The FAU may include a plurality of fiber couplers (e.g., v-grooves, u-grooves, and/or the like) into which optical fibers (e.g., single mode fibers, multi-mode fibers, polarization maintaining fibers, and/or the like) may be positioned and held in place (e.g., using an adhesive). The FAU may be formed from a substrate, and the fiber couplers may be formed in a surface of the substrate (e.g., using a beveled blade with a dicing saw machine, by chemical etching of the substrate, and/or the like). The fiber couplers may extend substantially parallel to each other on the surface of the substrate.

The disclosed systems and methods may be implemented using co-packaged optical (CPO) solutions integrated with electronic switch ASICs, network processors, or AI accelerators. Optical components such as modulators, drivers, photodetectors, and laser sources may be co-packaged directly on or near the host silicon using advanced packaging technologies including 2.5D interposers or silicon bridges. In some configurations, mid-board optical modules (MBOMs) are employed as part of the optical I/O strategy. MBOMs are positioned centrally on the PCB (between the front panel and the host die), enabling shorter electrical traces and improved signal integrity while maintaining separation between optics and high-power ASICs for thermal management. In some configurations, near-packaged optics may also be used, placing optical engines in close proximity to the host device without full co-packaging, allowing for modular deployment and gradual migration from pluggable optics.

The disclosed systems and methods may support optical connectivity through edge couplers, fiber ribbon interfaces, on-board photonic waveguides, or grating couplers. Silicon photonics may be used to implement optical engines within the CPO or MBOM units, with support for modulation schemes such as PAM4, coherent signaling, or WDM. These components may be interconnected via high-speed electrical interfaces such as SerDes lanes, and coordinated via on-board controllers that handle lane training, optical power tuning, and health monitoring.

Embodiments of the present disclosure may scale from 400 G to 1.6 T and beyond, supporting deployment in high-performance computing, AI clusters, and data center switching platforms. Integration strategies may include air-cooled and liquid-cooled packages, supporting advanced thermal designs to handle the combined electrical and optical power densities. In some configurations, the disclosed systems may be implemented in modular switch platforms, AI training fabrics, or other environments requiring high-density, low-latency interconnect.

In some configurations, the disclosed systems may be implemented in co-packaged datacenter switches or similar networking devices. Co-packaging may refer to the close integration of different electrical and/or optoelectronic chips in the same package. The different chips that constitute the co-packaged system are assembled on a single substrate in what is typically called a multi-chip module (MCM) assembly. A MCM assembly can include switching circuitry surrounded by one or more peripheral chips.

### Example System for Detachable Coupling

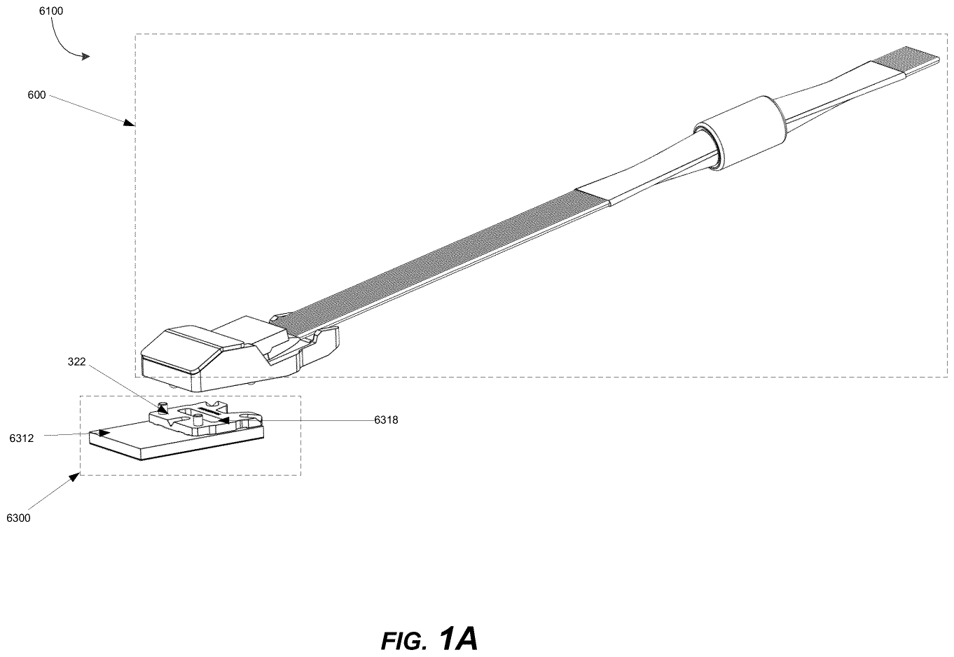

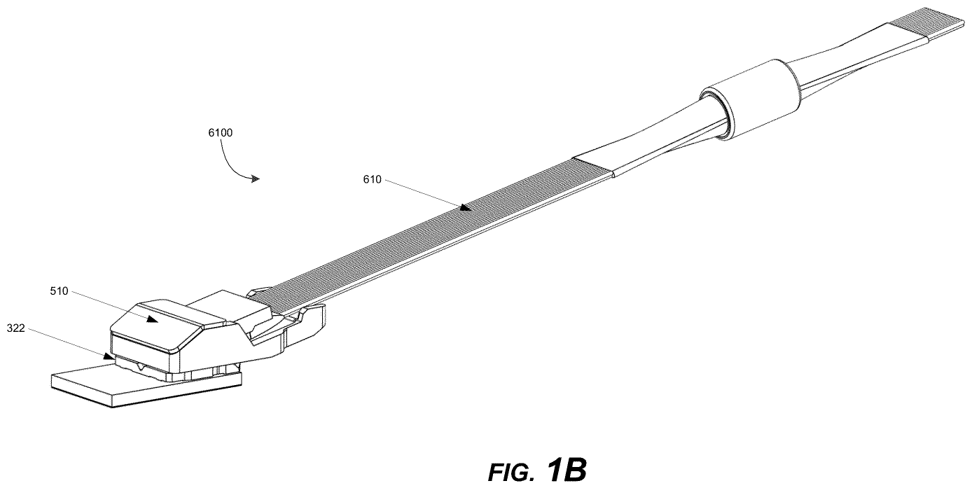

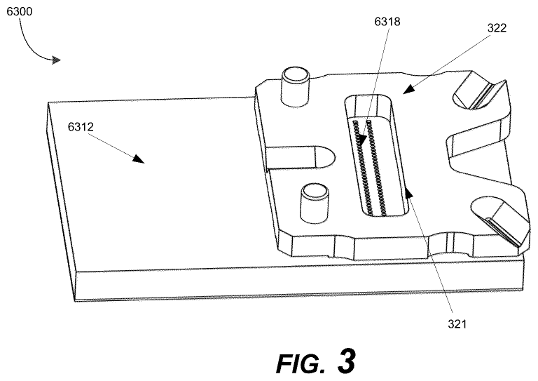

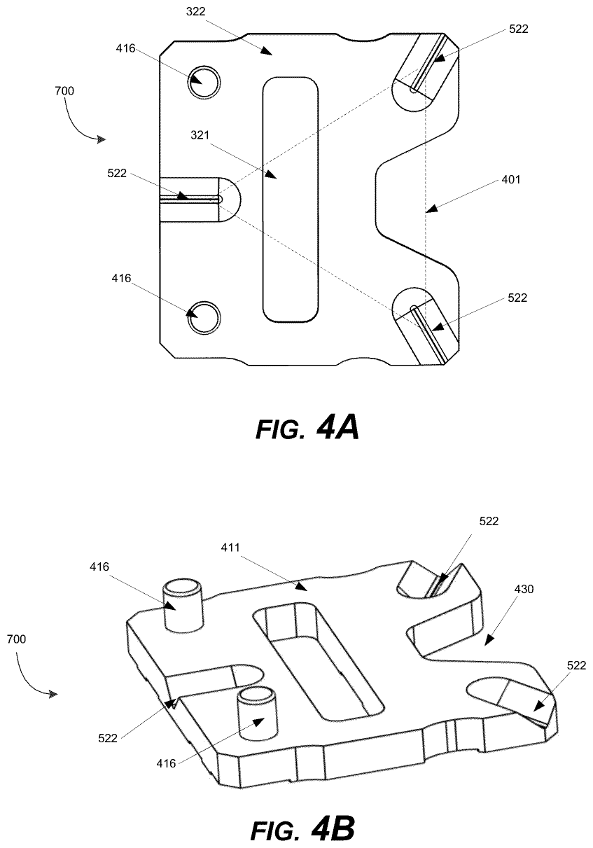

FIGS. 1A and 1B illustrate a system 6100 for detachable coupling between a fiber array unit (FAU) and a photonic integrated circuit (PIC), in accordance with embodiments of the disclosure. Specifically, FIG. 1A illustrates an embodiment of the system in a detached state, and FIG. 1B illustrates an embodiment of the system in an attached state. As illustrated, the system may include an optical connector 600 comprising an FAU 610 coupled to an attachment element 510 (e.g., a carrier). The system may further include an electronic module 6300, which may comprise a PIC 6318 on a substrate 6312 and a mounting element 322 (e.g., a receptacle). FIG. 1B illustrates the system in an attached state, in which the attachment element 510 of the connector 600 is coupled with the mounting element 322 of the electronic module 6300, which allows for an optical signal to be transmitted between the PIC 6318 and the FAU 610. Specifically, the mounting element 322 may comprise a plurality of first rough alignment elements configured to provide an initial alignment between the mounting element 322 and the attachment element 510, the initial alignment having a first predetermined tolerance. The attachment element 510 may comprise a plurality of first fine alignment elements configured to provide a secondary alignment between the mounting element 322 and the attachment element 510, the secondary alignment having a second predetermined tolerance less than the first predetermined tolerance. In some embodiments, the second predetermined tolerance is a sub-micron tolerance. The plurality of first rough alignment element and the plurality of first fine alignment elements (described in greater detail with respect to FIGS. 4A-4B) may allow the attachment element 510, in an attached state in which it is engaged with the FAU 610, to be detachably coupled to the mounting element 322 such that given fibers of the FAU 610 are aligned with a corresponding optical port of the PIC 6318 within the sub-micron tolerance. Although a single system 100 including a single PIC-mounting element assembly and a single attachment element-FAU assembly is shown in FIGS. 1A and 1B, one skilled in the art in view of this disclosure will understand that multiple PIC-mounting element assemblies and attachment element-FAU assemblies may be positioned or arranged in proximity to each other. For example, in some embodiments eight PIC-mounting element assemblies may be positioned in a side-by-side fashion and may be configured to engage eight corresponding attachment element-FAU assemblies. In addition, one skilled in the art in view of this disclosure will recognize that other geometries and arrangements of the kinematic mounting configuration described herein may be possible (e.g., the first rough alignment elements and/or the first fine alignment elements may be positioned on the mounting element, while second rough alignment elements (e.g., rough alignment cavities) and/or second fine alignment elements (e.g., fine alignment grooves) may be positioned on the attachment element, or each may be positioned on both).

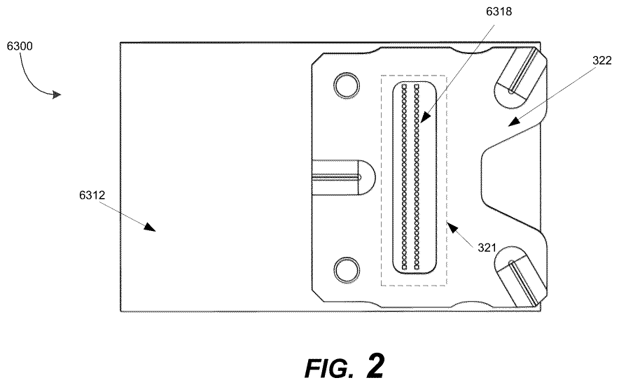

Turning now to FIGS. 2 and 3, an electronic module 6300 (e.g., an electronic device, a co-packaged optics (CPO) package, a chip-on-wafer device, a silicon PIC, a photonic wafer, and/or the like) is shown, where the electronic module comprises the PIC 6318 and the mounting element 322 shown in FIG. 1A. The electronic module 6300 may be configured to operate within or in conjunction with a broader network architecture. Various components of the electronic module 6300 described herein may interact with the network architecture to facilitate communication, data processing, and overall system management. In particular, the electronic module 6300 may leverage the underlying network topology (e.g., datacenter network topology) for efficient data transmission, whether through high-speed interconnections or optimized routing protocols.

As shown in FIGS. 2 and 3, the electronic module 6300 may include a substrate 6312 and at least one optical device depicted as a PIC 6318 (e.g., a chip containing a plurality of photonic components that may form a functioning circuit and/or that may generate, transmit, detect, and/or process light). The substrate 6312, for example, may be a printed circuit board, a metal carrier, an organic carrier, and/or a ceramic carrier. For example, the PIC 6318 may be an electro-optic modulator, a photodiode, a transmitter optical sub-assembly and/or a receiver optical sub-assembly. As will be appreciated by those of ordinary skill in the art in view of this disclosure, the PIC 6318 is an example of an optical device with which mechanical couplers for detachably connecting FAUs may be used. Other example optical devices may include surface emitting/absorbing electro-optics devices such as VCSELs, SiP devices (e.g., grating couplers, edge couplers), photodetectors, and/or the like.

With continued reference to FIGS. 2 and 3, the PIC 6318 may be positioned on a peripheral portion of the substrate 6312, depicted in FIGS. 2 and 3 on the righthand side of the substrate. As shown in FIGS. 2 and 3, the mounting element 322 (described in greater detail with respect to FIGS. 4A-4B) may include an optical window 321, which may be positioned with respect to the PICs 6318 such that the PIC 6318 is accessible via the optical window 321. The optical window 321 may comprise an aperture (e.g., a cut-out portion or the like) through the material of the mounting element 322 configured to allow the fibers of the FAU 610 to propagate light through the optical window 321 into the PIC 6318.

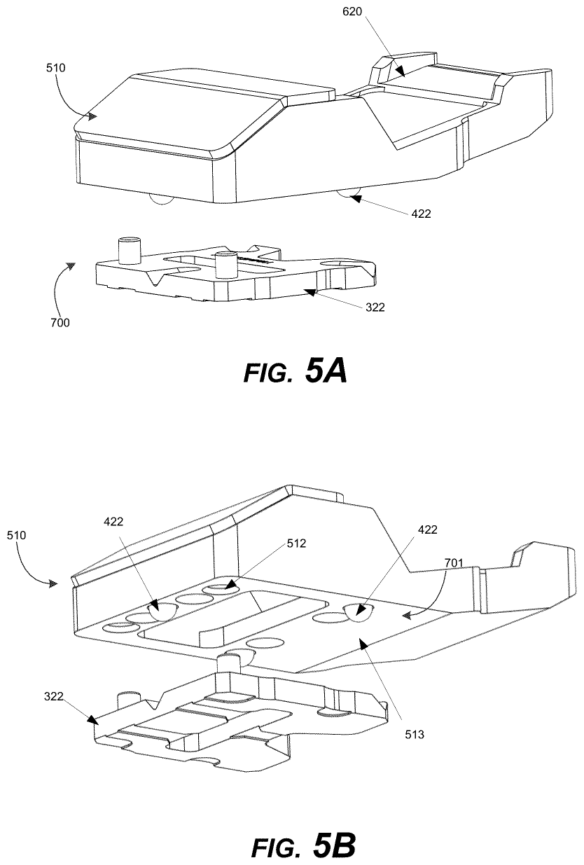

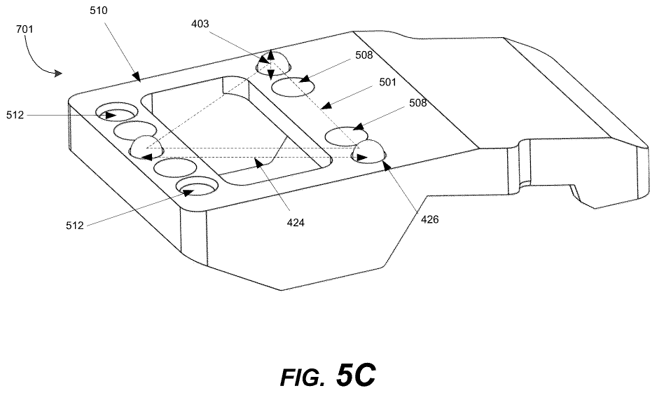

In some embodiments, the mounting element 322 may be bonded and actively aligned to the PIC 6318 to form a SiP with mounting element stack during manufacturing. The mounting element 322 may be configured to removably engage with the attachment element 510 (illustrated in FIGS. 5A-5B). The attachment element 510, in turn, may be attached to an FAU to form a detachable connector 600 (as illustrated in FIGS. 1A-1B), which may be further be connected via optical fibers of the FAU to an optical connector (e.g., an MPO connector, an attachment element of another detachable connector, and/or the like) that is in optical communication with one or more optical devices (not pictured). In this way, the mounting element 322 and the attachment element 510 may be configured to detachably optically connect the PIC 6318 of the electronic module 6300 to one or more other optical devices in a network. In some embodiments, the PIC 6318 may be configured to convert electrical signals to optical signals and transmit the optical signals via the detachable connector 600 to one or more optical devices. Additionally, or alternatively, the PIC 6318 may be configured to receive optical signals from one or more optical devices and convert the optical signals to electrical signals.

FIGS. 4A-4B schematically depict a kinematic interface 700 of the mounting element 322 of the electronic module 6300, in accordance with an embodiment of the present disclosure. As depicted, the mounting element 322 may comprise a substantially planar body 411 that defines the optical window 321. The optical window 321 may be configured to allow optical signals to pass between the PIC 6318 and the detachable connector 600. The planar body may comprise a material having a relatively low coefficient of thermal expansion (CTE), such as glass or metal (e.g., Kovar® alloy, Invar® alloy, copper, or the like). Furthermore, the planar body may comprise a material having a CTE approximately similar to the CTE of the substrate 6312 to prevent deformation and maintain optical performance during temperature changes. In some embodiments, the kinematic interface 700 of mounting element 322 may comprise at least one first rough alignment element supported by the planar body 411, such as two first rough alignment elements 416, as shown in the depicted embodiment. Each first rough alignment element 416 may extend from the planar body 411 and may be configured to provide rough alignment of the mounting element 322 with the attachment element 510, as described in greater detail below. In the depicted embodiment, for example, each first rough alignment element 416 is disposed in a corner of the mounting element 322; however, other arrangements of the first rough alignment elements are possible. Each first rough alignment element may be substantially column-shaped (e.g., a peg, pillar, cone, or the like) and may be formed integrally with the planer body or may be affixed to the planar body during a manufacturing process, such as via welding or use of an adhesive.

The kinematic interface 700 of the mounting element 322 may further comprise a plurality of second fine alignment elements 522 (e.g., fine alignment grooves, as depicted) positioned on the planar body 411, where each second fine alignment element 522 is configured to receive a corresponding first fine alignment element 422 of a second kinematic interface 701, described in greater detail with respect to FIGS. 5A-5C. In some embodiments, each second fine alignment element 522 is a groove that is substantially V-shaped, such that each first fine alignment element 422 (e.g., each sphere in the embodiment depicted in FIGS. 5A-5C) contacts the inner surface of each second fine alignment element 522 (e.g., each groove in the depicted embodiment) at two points, when engaged. In other embodiments, each second fine alignment element 522 may be structured other than a V-shaped groove. For example, two parallel cylinders or sections of cylinders may be used to provide two points of contact with each first fine alignment element 422, when engaged. In some embodiments, the second fine alignment elements 522 comprise a material having a hardness of around 36-40 on the Rockwell C scale and a CTE of around 8.6×10⁻⁶/K (e.g., titanium) to maintain precision and reduce stress under heat. Furthermore, the second fine alignment elements 522 may each comprise a friction-reducing coating (e.g., a diamond-like carbon (DLC) coating, molybdenum disulfide coating, tungsten disulfide coating, or the like) configured to prevent or reduce an amount of friction created at the contact points between the second fine alignment elements 522 and the first fine alignment elements 422, as well as increase the hardness of the second fine alignment elements (e.g., to approximately 48-55 on the Rockwell C Scale). The second fine alignment elements 522 may be integrally formed in the mounting element 322 via an injection molding process or may be formed by removing material from the mounting element 322 via a metal machining process. In some embodiments, the kinematic interface 700 may comprise three second fine alignment elements 522 arranged in a triangular configuration on the planar body 411, where the optical window 321 is at least partially located within the triangle 401 formed by the first fine alignment elements 422.

The planar body 411 of the mounting element 322 may be substantially rectangular or square in shape, and in some embodiments the peripheral edge of the planar body may include one or more indentations, cutouts, or transmission windows (e.g., a cutout 430) configured to accommodate one or more system components (e.g., portions of the detachable connector 600, one or more tools used during installation and/or maintenance, and/or the like). In some embodiments, wherein the cutout 430 comprises a transmission window, the transmission window may comprise a material associated with an optical wavelength that matches a predetermined optical wavelength (e.g., glass, silicon, or the like) and may further comprise an antireflective coating on a top and/or bottom side. Furthermore, the planar body 411 may comprise a substantially planar top surface and/or bottom surface in some embodiments, whereas in other embodiments the planar body may comprise one or more ridges (e.g., raised portions, bevels, textures, and/or the like) on one or both of the top and bottom surfaces, depending on one or more system requirements, user preferences, and/or manufacturing considerations (e.g., improved bonding between the mounting element 322 and the substrate 6312, providing access to the optical window 321 for cleaning or maintenance, and/or the like).

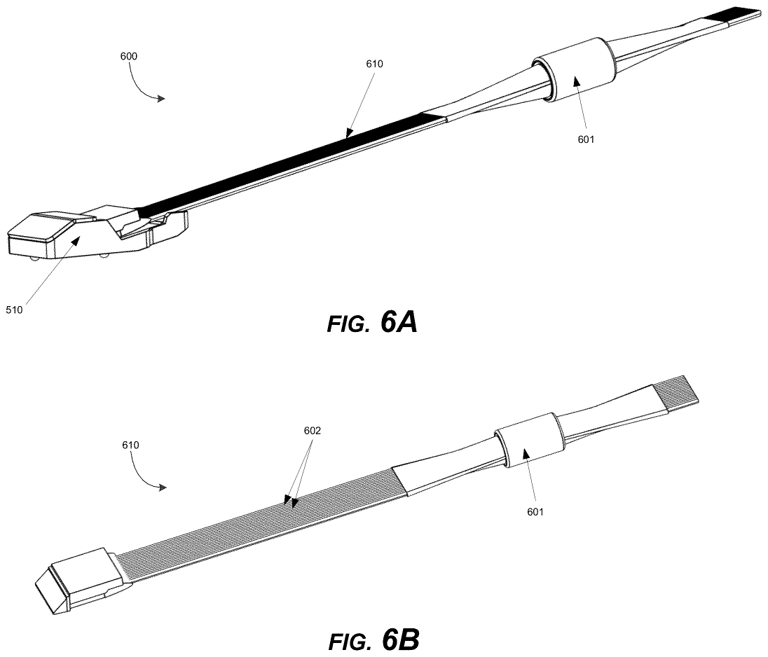

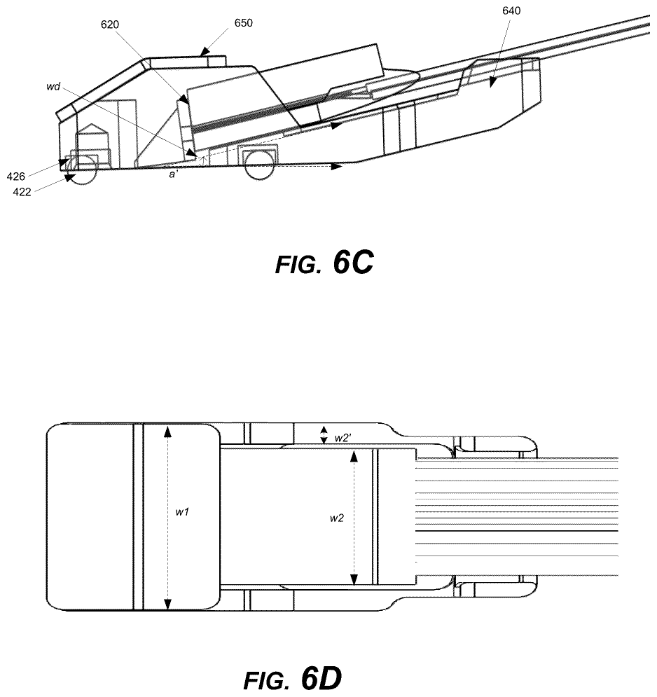

FIGS. 5A-5C depict perspective views of the kinematic interface 700 of the mounting element 322 and a corresponding kinematic interface 701 of an attachment element 510. The attachment element 510 may comprise a material having a relatively low coefficient of thermal expansion (CTE), such as glass or metal (e.g., Kovar® alloy, Invar® alloy, copper, or the like). In some embodiments, the attachment element 510 may comprise Kovar® and may further comprise an outer plating (e.g., a nickel plating). As described in greater detail with respect to FIGS. 6A-6B, the attachment element 510 may be attached to a fiber array unit (FAU) to form the detachable connector 600. The kinematic interface 701 of the attachment element 510 may comprise at least one second rough alignment element 512 (e.g., a rough alignment cavity) (shown in FIGS. 5B and 5C), where each second rough alignment element 512 is configured to engage a corresponding first rough alignment element 416 of the kinematic interface 700 of the mounting element 322. The second rough alignment element 512 may be a rough alignment cavity that may, for example, have a tapered inner surface, such that a diameter of the cavity proximate a bottom surface of the attachment element 513 is larger than a diameter of the cavity more distal from the bottom surface. In this way, each second rough alignment element 512 of the kinematic interface 701 may self-align with a corresponding first rough alignment element 416 of the kinematic interface 700 by receiving the first rough alignment element via the larger diameter portions of the cavity and allowing the first rough alignment element to slide along the inner surface of the cavity toward the narrower diameter portions of the cavity, thereby adjusting the location of the first rough alignment element with respect to the attachment element 510. Additionally or alternatively, the kinematic interface 701 may comprise one or more first rough alignment elements 416 as described with respect to FIGS. 4A-4B, and the kinematic interface 700 of the mounting element 322 may comprise one or more corresponding second rough alignment elements 512, in order to provide a rough alignment of the mounting element 322 with the attachment element 510.

The kinematic interface 701 of the attachment element 510 may further comprise a plurality of first fine alignment elements 422 positioned on the bottom surface 513 of the attachment element 510. In some embodiments, as depicted in FIGS. 5A-5C, each of the plurality of first fine alignment elements 422 may comprise a sphere. In some embodiments, the kinematic interface 701 may comprise three first alignment elements 522 arranged in a triangle 501 corresponding to the triangle 401 formed by the first fine alignment elements 422 of the kinematic interface 700. In some embodiments, each first fine alignment element 422 may be positioned such that a pitch 424 of the first fine alignment elements 422 with respect to each other is within a predetermined range of final pitches. For example, in embodiments in which the first fine alignment elements 422 form a triangle 501, the first fine alignment elements may be positioned with respect to each other such that a distance 424 between two first fine alignment elements 422 is within a predetermined range of distances (e.g., within ±1-3 μm of a predetermined distance). Additionally or alternatively, the first fine alignment elements 422 may be positioned such that a height 403 of the top of each first fine alignment element 422 with respect to a surface of the attachment element 510 is substantially the same (e.g., ±1-3 μm from a predetermined height).

The kinematic interface 701 may further comprise a plurality of concavities 426, with each concavity 426 being configured to receive a first fine alignment element 422. For example, each concavity 426 may comprise a semicircular or a hemispherical shape. In some embodiments, the first fine alignment elements 422 may comprise a ceramic material and may be fixed within and with respect to the concavities 426, such as via an adhesive, epoxy, bonding, or the like. In some embodiments, the first fine alignment elements 422 may comprise glass and may be directly mounted to the attachment element 510 or integrally formed within the plurality of concavities during a manufacturing process. In some embodiments, the kinematic interface may further comprise a plurality of additional cavities configured to receive a plurality of magnets (not depicted), the plurality of magnets being configured to provide additional adhesion and stability between the attachment element 510 and the mounting element 322 when the detachable connector 600 is in an attached state.

In some embodiments, the mounting element 322 may comprise a plurality of concavities 426, with each concavity being configured to receive a first fine alignment element 422, as described with respect to FIGS. 1A-4B, and the attachment element 510 may comprise a plurality of corresponding second fine alignment elements 522 (e.g., fine alignment grooves) (e.g., as depicted in FIGS. 6A-6D).

With reference to FIGS. 5A-5C, the attachment element 510 may be configured to receive and optically couple with an FAU 610 so as to form a detachable optical connector 600. In some embodiments, the detachable optical connector 600 may comprise a strain relief harness (e.g., a boot) 601 coupled to the FAU 610, which may be coupled to one or more other system components (not pictured) to relieve strain on the fibers 602 of the FAU 610 during shipment, assembly, and operation. The FAU 610 and the attachment element 510 may be configured such that the attachment element 510 may receive the FAU 610 and both mechanically and optically couple the optical fibers 602 of the FAU 610 to the electronic module 6300. In particular, and as described further herein, the FAU 610 and the attachment element 510 may be configured to precisely mechanically align with each other such that when the attachment element 510 is coupled to the mounting element 322 via the kinematic interfaces 700 and 701, each of the optical fibers 602 is precisely optically aligned with a corresponding optical aperture (e.g., an optical channel or lens configured to allow light (e.g., an optical signal) to pass therethrough)) and waveguide of the PIC 6318 of the electronic module 6300.

As shown in FIGS. 5A and 6C, the attachment element 510 may comprise a first bonding surface 620 configured to couple with a corresponding surface of the FAU 610. As depicted, the first bonding surface 620 may be positioned at an angle α′ with respect to a second bonding surface 530 (e.g., a bottom surface and/or the kinematic interface 701) of the attachment element 510, where the angle is selected to minimize a working distance wd between the end of each fiber 602 of the FAU 610 and the corresponding optical ports (not shown in FIG. 6C) of the electronic module 6300. As illustrated in FIG. 6C, the angle α′ minimizes the distance wd between the FAU 610 and the second bonding surface 530 of the attachment element, but still allows for enough clearance considering the height of the second fine alignment elements 522 or the plurality of concavities 426 formed in the attachment element. Specifically, the angle α′ is selected in order to allow the end of each fiber 602 to be positioned as closely as possible to the second bonding surface 530, while providing space for the second fine alignment elements 522 (e.g., the grooves) to extend upward into the body of the attachment element 510. The detachable connector 600 may further comprise a gap 640 between the body of the attachment element 510 and the fibers 602 of the FAU 610, in order to provide strain relief to the fibers 602 and to otherwise minimize mechanical forces acting on the fibers 602. As illustrated in FIG. 6D, which depicts a partial bottom view of the detachable connector 600, the attachment element 510 may have a width w1 (e.g., approximately 7-7.4 mm), while the FAU 610 may have a width w2 (e.g., approximately 5.2-5.7 mm). Width w2 may be slightly shorter than width w1, such that a gap having a width w2′ (e.g., approximately 0.1-0.2 mm) is created on either side of the FAU 610 when coupled to the attachment element 510. FIG. 6E depicts an embodiment of the electronic module 6300 detachably coupled to the detachable connector 600, with the FAU 610 affixed to the attachment element 510 and the mounting element 322 affixed to the PIC 6318. In some embodiments, the attachment element 510 and the mounting element 322 are maintained in a coupled configuration using a force application mechanism that applies a force F to a push plate 650 that is applied or attached to a top surface of the attachment element 510, as shown in FIGS. 6C and 6E.

In this regard, the push plate 650 may be attached to the top surface of the attachment element 510, such that when a downward force F is applied to the push plate, the fine alignment grooves 522 of kinematic interface 700 engage with the first fine alignment elements 422 of the kinematic interface 701, preventing the attachment element 510 from moving with respect to the mounting element 322. In some embodiments, the force application mechanism may be configured to apply a force of approximately 2N-10N (e.g., around 4N, in some embodiments) to the push plate 650. Moreover, in some embodiments, the push plate 650 may be positioned at least partially within the triangular configuration 501 formed by the first fine alignment elements 422, such that the location of the push plate causes a net downward force to be applied by the force application mechanism. In some embodiments, for example, the net downward force is applied to the center of the triangular configuration 501 (shown in FIG. 5C), thereby evenly distributing the force among the first fine alignment elements 422 and facilitating a more precise alignment of the first fine alignment elements 422 within the second fine alignment elements 522.

### Example Method of Assembling a Detachable Connector

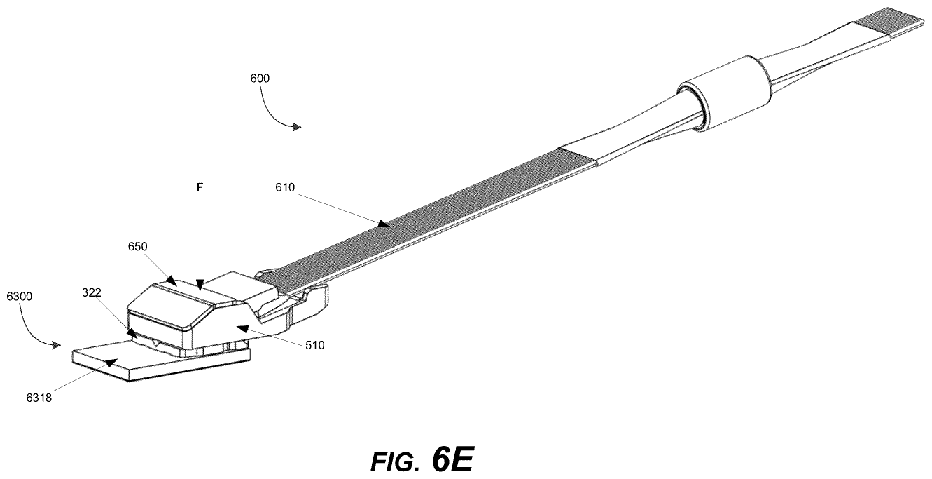

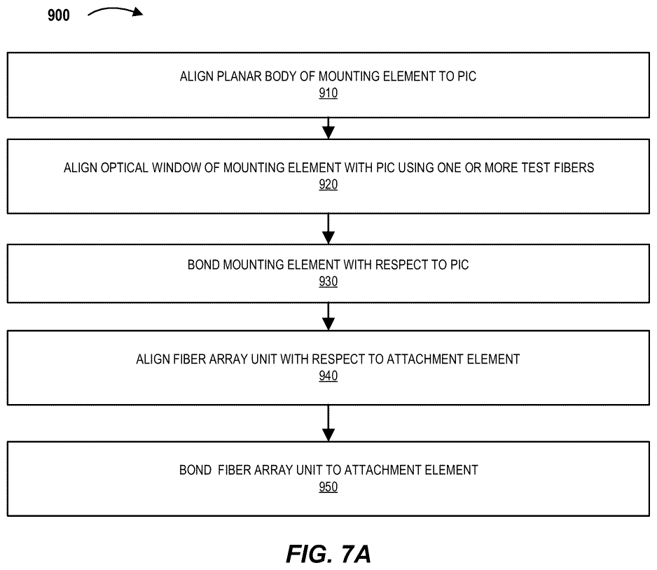

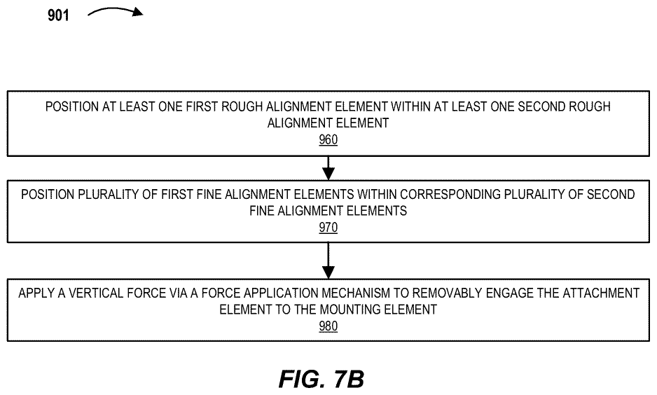

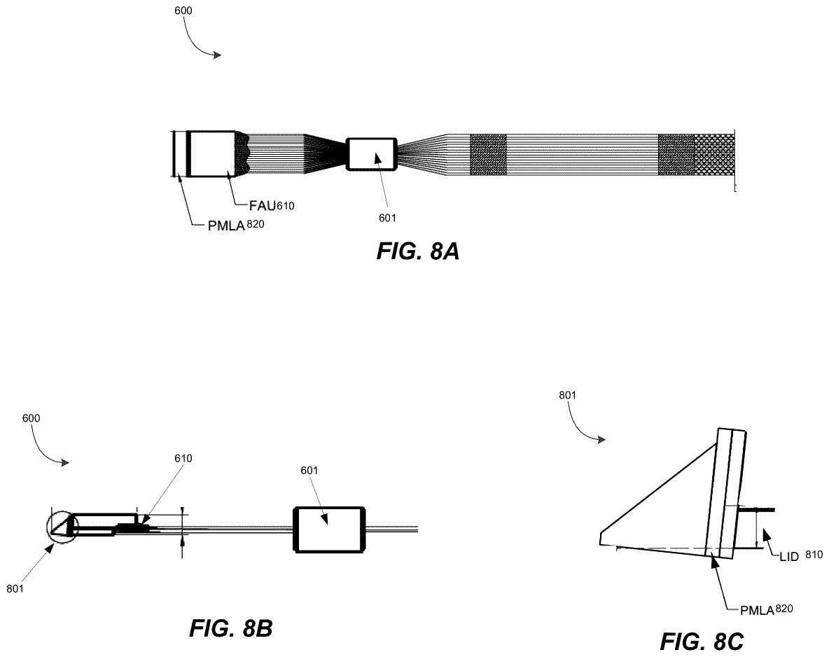

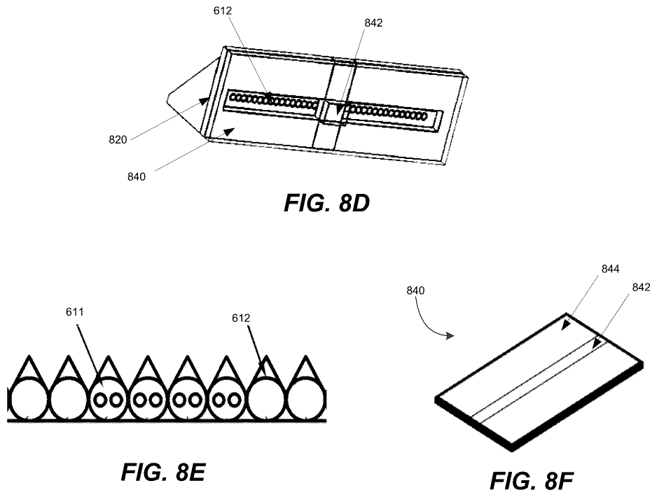

FIG. 7A is a flowchart illustrating a method 900 of assembling a detachable connector for detachably coupling an FAU 610 to an electronic module 6300, in accordance with an embodiment of the present disclosure. In some embodiments, the method 900 may begin at Block 910, comprising placing the planar body of the mounting element (e.g., the mounting element 322 of FIGS. 7-8 described above) in alignment with respect to the PIC 6318. In some embodiments, a magnet may be used to move the planar body of the mounting element with respect to the PIC 6318 to achieve alignment. In some embodiments, Block 910 comprises aligning each mounting element of a group of mounting elements to a corresponding group of PICs 6318 to form the electronic module 6300. In some embodiments, the planar body of the mounting element may be mounted to an alignment tool which mimics the attachment element 510.

With reference to Block 920, the optical window of the mounting element may then be aligned with respect to the PIC 6318 using one or more test fibers. The test fibers may, for example, form part of a testing system that is designed to mimic an attachment element and FAU. The testing system may be configured to obtain at least one optical feedback measurement via the one or more test fibers, and the feedback measurement may inform further movement of the mounting element with respect to the PIC 6318 to improve the alignment of the optical window with the PIC. Once the mounting element is aligned such that the one or more test fibers are sufficiently precisely aligned with the PIC 6318, the method may continue to Block 930, in which the mounting element is held in place with respect to the substrate 6312 while being bonded to form the electronic module (e.g., thermally bonded, adhesively bonded, or the like). In some embodiments, the alignment process of Block 920 is repeated with respect to each mounting element of the group of mounting elements.

In Block 940, the FAU 610 may be aligned with respect to the attachment element 510. For example, in some embodiments, the attachment element 510 may be mounted on an optical engine configured to mimic components of the electronic module 6300. Then, the FAU 610 may be aligned to the attachment element 510 using one or more test fibers. The optical engine may be configured to obtain at least one optical feedback measurement via the one or more test fibers, and the feedback measurement may inform further movement of the FAU 610 with respect to the attachment element 510. Once the FAU 610 is aligned such that the one or more test fibers are sufficiently precisely aligned with the optical engine, the method may continue to Block 950.

In Block 950, the attachment element may be coupled to the FAU via the bonding surface of the attachment element, as described above with respect to FIG. 6C. In some embodiments, a plurality of attachment elements 510 may be coupled to a plurality of FAUs 610 to form a group of connectors.

In some embodiments the method 900 may include additional steps, such as any single step or any combination of steps described herein. Although FIG. 7A shows example blocks of the method 900, in some embodiments, the method 900 may include additional blocks, fewer blocks, different blocks, or differently arranged blocks than those depicted in FIG. 7A. Additionally, or alternatively, two or more of the blocks of method 900 may be performed in parallel.

### Example Method of Detachably Coupling an Electronic Module to an Fau

FIG. 7B is a flowchart illustrating a method 901 of detachably coupling an FAU 610 to an electronic module 6300, in accordance with an embodiment of the present disclosure. In some embodiments, the method may begin at Block 960, where the at least one first rough alignment element of the mounting element may be positioned within the at least one second rough alignment element (e.g., a rough alignment cavity) of the attachment element. In some embodiments, Block 960 may comprise positioning at least one first rough alignment element of the attachment element within at least one second rough alignment element (e.g., a rough alignment cavity) of the mounting element. At Block 970, the plurality of first fine alignment elements (e.g., spheres) of the mounting element may be positioned within the plurality of second fine alignment elements (e.g., grooves) of the attachment element. In some embodiments, however, a plurality of first fine alignment elements (e.g., spheres) of the attachment element may be positioned within a plurality of second fine alignment elements (e.g., grooves) of the mounting element. In some embodiments, the steps of Blocks 960 and 970 may be performed simultaneously (e.g., by positioning the attachment element on top of the mounting element such that all corresponding components align with one another). Furthermore, in some embodiments, the steps of Blocks 950 and 960 may be performed simultaneously with respect to each connector 600 and corresponding mounting element 322 of the group of connectors and the group of mounting elements. Furthermore, in some embodiments, an initial alignment of the group of connectors with respect to the group of mounting elements may be achieved via an assembly rig configured to maintain the group of connectors 800 within a predetermined position during manufacturing, shipping, etc.

Once the attachment element and the mounting element are aligned and engaged, a vertical force may be applied to the attachment element at Block 980 via a force application mechanism such that the plurality of first fine alignment elements engages with the plurality of second fine alignment elements. In some embodiments, engaging the force application mechanism comprises applying a vertical downward force to the push plate positioned at the top of the attachment element, such that a net downward force is applied to an area within a triangle formed by the plurality of second fine alignment elements, as described above with respect to FIGS. 4A and 4B. In the attached state, the kinematic interface of the attachment element may be engaged with the corresponding kinematic interface of the mounting element such that optical signals are able to propagate between the fibers of the FAU and a corresponding PIC of the electronic module.

In some embodiments the method 901 may include additional steps, such as any single step or any combination of steps described herein. Although FIG. 7B shows example blocks of the method 901, in some embodiments, the method 901 may include additional blocks, fewer blocks, different blocks, or differently arranged blocks than those depicted in FIG. 7B. Additionally, or alternatively, two or more of the blocks of method 901 may be performed in parallel.

### Example Detachable Connector With Polarization Plate

In some embodiments, the detachable connector may couple optical signals into two output waveguides. Because the two waveguides may exhibit different polarization-dependent loss (PDL) or polarization-dependent coupling efficiency, one polarization state may couple preferentially into one waveguide, while the orthogonal polarization couples preferentially into the other. This imbalance results in unequal power distribution (e.g., a power asymmetry) between the two outputs, which may result in degradation of system performance and, at high power, may result in damage to the PIC. Each rotation tolerance may add more power to the perpendicular axis.

To solve this problem, the detachable connector may integrate a linear polarizer to improve polarization control. The polarizer may be integrated into polarization-maintaining (PM) channels of the optical connectors to ensure correct polarization orientation into photonic integrated circuits (PICs), improving performance and reducing damage risks caused by fiber clocking tolerances. The polarizer may be configured to eliminate power in the orthogonal polarization, thereby ensuring an equal distribution of power between the two waveguides and preventing damage to the PIC. Specifically, the electric field vector (E) of the optical signals may comprise orthogonal components(E_{S}) and parallel components (E_{P}). Assuming that √C̅ₛ=√C̅ₚ=1, where C refers to a power coefficient, it is desirable that the power output at the left waveguide (P_{L}) is approximately equal to the power output at the right waveguide (P_{R}), such that P_{L}≅|E_{S}+Eₚ|²≅|E_{S}−Eₚ|². The components E_{S} and E_{P} may be derived from a known angle shift (θ) such that Eₛ≅α₀·sin (θ) and E_{P}≅α₀·cos (θ). By using a polarizer to eliminate the orthogonal components E_{S}, the system may achieve an even power distribution between the output channels. The goal is to ensure an approximately 50/50 split by the 2DGC coupling even if input beam polarization is not perfect due to tolerances.

FIGS. 8A-8D illustrate a detachable optical connector 600, in accordance with embodiments of the invention. Specifically, FIG. 8C illustrates a detailed view of a connection portion 801 of the detachable optical connector 600 (shown in FIG. 8B). With reference to FIGS. 8A-8C, the detachable optical connector 600 may comprise a laser interface device (LID) 810, a planar microlens array (PMLA) 820, and an FAU 610 configured to operate as an integrated optical pathway that converts electrical signals to optical signals with low transmission loss. The detachable optical connector 600 may further comprise a strain relief harness 601 as described with respect to FIGS. 6A-6B. The LID 810 may comprise an array of laser diodes or the like (e.g., vertical-cavity surface-emitting lasers) configured to serve as an active light source for one or more transmit channels. The LID 810 may further comprise one or more photodiodes configured to operate as receive channels. The PLMA 820 may comprise one or more microlenses and may be positioned adjacent to one or more fibers of the FAU 610 in order to collimate (e.g., focus) an optical signal from each of the one or more fibers into a specific optical aperture of the PIC 6318 (shown in FIG. 6E).

The FAU 610 may be configured to provide a mechanical interface between the collimated beams and the terminating ends of the one or more fibers. During assembly, the alignment of the PMLA 820, FAU 610, and LID 810 may be adjusted in real time until maximum optical coupling efficiency is achieved across all channels. Once aligned, the components may be locked in place (e.g., using high-stability epoxies, solder bonding, and/or the like) to ensure mechanical robustness under thermal cycling and vibration. In operation, this arrangement minimizes insertion loss, reduces back reflection, and provides stable multi-channel coupling between integrated photonic devices and fiber arrays, enabling high data rates and low error performance in an optical communication system.

In some embodiments, as illustrated in FIG. 8D, the detachable optical connector may include a polarization plate 840 (e.g., a polarization beam splitter plate or the like). In some embodiments, the polarization plate 840 may be attached or detached to the detachable optical connector. Furthermore, in some embodiments, the polarization plate 840 may comprise one or more anti-reflective (AR) coated facets when coupled with other components providing partially-reflective (PR) facets, such as an external cavity mirror, a laser, or the like. The polarization plate 840 may be positioned adjacent to the PMLA 820 to control the polarization state of the transmitted light. For example, in some embodiments, the polarization plate may be configured to align all optical channels to a common polarization axis or to separate orthogonal polarizations for polarization-division multiplexing. In some embodiments, the polarization plate 840 is configured to ensure that optical signals from the LID 810 maintain a desired polarization orientation as they pass into the fibers of the FAU 610, thereby improving coupling efficiency in systems where the downstream photonic circuitry is polarization-sensitive. Additionally or alternatively, the polarization plate 840 may be used to split incoming optical signals into one or more distinct polarization channels, each directed toward separate detectors of the PIC 6318, thereby increasing the channel capacity without increasing fiber count. The polarization plate 840 may be precisely aligned with respect to the PMLA 820 and may be bonded in a fixed orientation (e.g., via glue, epoxy, or the like).

In some embodiments, as illustrated in FIGS. 8D-8E, only a subset of the fibers within the FAU are polarization-maintaining (PM) fibers 611, while the remaining channels may use standard single-mode fibers 612 that are not polarization sensitive. This mixed configuration between PM fibers 611 and single-mode fibers 612 may provide for an optical communication system wherein certain wavelengths and/or signal paths carry polarization-encoded data (e.g., feed polarization-sensitive photonic integrated circuits), while other channels operate with conventional intensity-modulated signals. In such embodiments, as illustrated in FIG. 8F, the polarization plate 840 may comprise a polarization portion 842 selectively aligned to the subset of PM fibers 611 to ensure that their input polarization is properly oriented according to a predetermined configuration, thereby preserving the polarization extinction ratio (PER) of the optical signals passing therethrough. The polarization plate 840 may further comprise a non-polarizing portion 844 aligned with the single-mode fibers 612, which enables the single-mode fibers 612 to transmit light directly through the polarization plate 840 without polarization alignment. Thus, the polarization plate 840 may cover the full PMLA 820 for mechanical simplicity and ease of coupling to a corresponding PIC, but functionally, only those channels coupled into PM fibers 611 (e.g., channels overlaid by the polarization portion 842) experience polarization.

Accordingly, the detachable optical connector of FIGS. 8A-8D may comprise an FAU comprising a plurality of optical fibers arranged at a predetermined pitch, wherein at least one of the optical fibers comprises a PM fiber and at least one of the optical fibers comprises a single-mode fiber. The detachable optical connector may further comprise a polarization plate (e.g., the polarization plate illustrated in FIG. 8F), the polarization plate comprising a first portion configured to align a polarization state of a first optical signal with a polarization axis of the PM fiber and a second portion configured to allow a second optical signal to pass therethrough without polarization alignment. Additionally or alternatively, the detachable optical connector of FIGS. 8A-8D may comprise an FAU comprising an array of optical fibers, wherein a first subset of the array comprises at least one PM fiber and wherein a second subset of the array comprises at least one single-mode fiber. The detachable optical connector may further include a polarization plate (e.g., the polarization plate illustrated in FIG. 8F) positioned in an optical path of the array of the optical fibers, wherein the polarization plate comprises a polarizing portion arranged in an optical path of the at least one PM fiber and a non-polarizing portion arranged in an optical path of the at least one single-mode fiber.

### Example Network Architecture

Datacenters and other networking systems may include connections between datacenters, switch systems, servers, racks, and devices in order to provide for signal transmission between one or more of these elements. These connections may be made using cables, transceivers, interconnects, interposers, and connector assemblies. For high bandwidth applications and/or connections over long distances, high powered optical communications may be preferred to ensure signal transmission integrity.

FIG. 9 illustrates an example network architecture 10, in accordance with an embodiment of the disclosure. As shown in FIG. 9, the network architecture 10 may include a datacenter 12, a communication network 14, and network device(s) 16. It is to be understood that the network architecture 10 may depict the general computing architecture within which more specific systems and/or subsystems may function. The network architecture 10 may provide a broad, abstract representation of the overall infrastructure, allowing for the inclusion of various configurations and implementations of the individual components without limiting the scope of the disclosure.

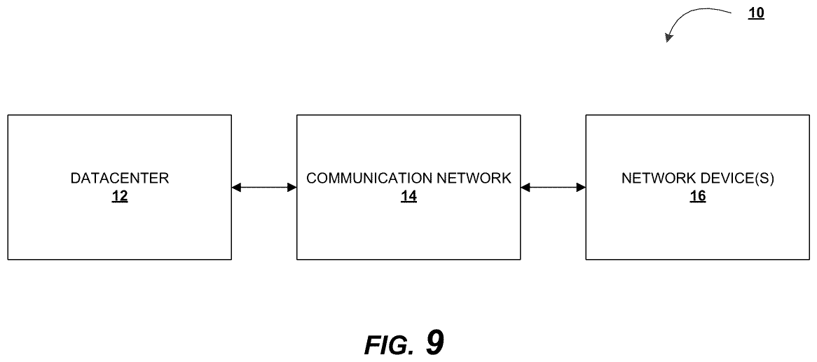

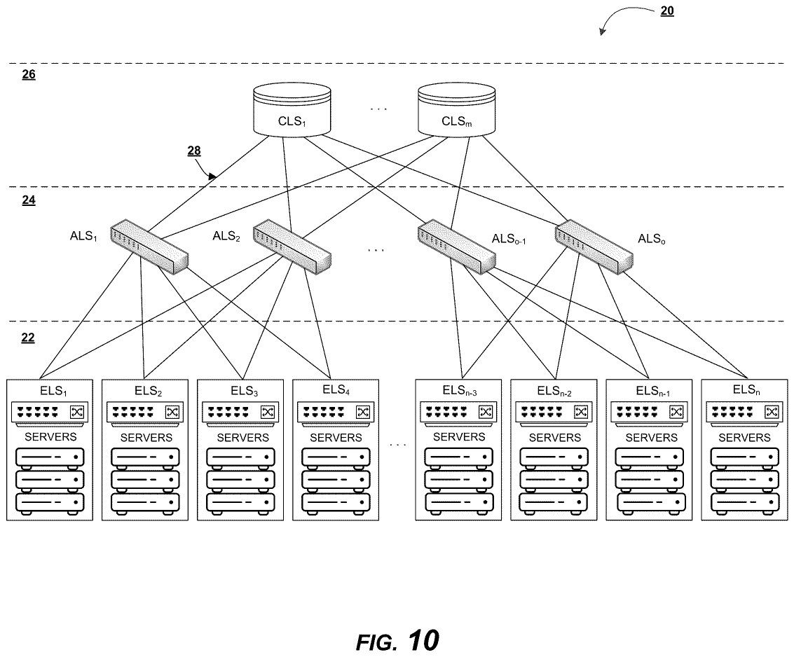

The datacenter 12 may be a centralized facility designed to house computing resources and related components. The primary function of the datacenter 12 may be to support the infrastructure required for advanced computational tasks, for efficient, secure, and reliable operations. The datacenter 12 may include building and structural components, including power supplies, cooling systems, fire suppression systems, and physical security measures that are configured to maintain optimal operating conditions and protect the equipment from environmental hazards and unauthorized access. At its core, the datacenter 12 may include high-performance servers or compute nodes, often arranged in racks, and connected through high-speed networks, as described in more detail in FIG. 10. These servers may include processors (e.g., central processing units (CPUs), graphics processing units (GPUs), a data processing unit (DPU), a quantum processing unit (QPU) or a physics processing unit (PPU) and/or the like), memory (e.g., RAM), and storage solutions (e.g., hard disk drives (HDDs), solid state drives (SSDs), and/or the like). QPUs may be configured to perform one or more operations associated with a quantum algorithm. In some embodiments, each of the one or more QPUs may include a plurality of qubits and the one or more QPUs may be in communication with each other via a quantum channel. Additionally, or alternatively, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with. The hardware configuration may be optimized for parallel processing and high throughput, catering to the demands of high-performance computing (HPC) applications.

The datacenter 12 may include high-speed network equipment, such as network switches, routers, firewalls, and/or the like to facilitate fast and secure data transmission within the datacenter 12 (e.g., between the servers or compute nodes) and between external networks. The datacenter 12 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the datacenter 12 can support high-performance computing tasks. Examples of various network topologies may include hierarchical networking topologies such as the fat tree topology, Slim Fly topology, Dragonfly topology, and/or the like.

The communication network 14 may operatively couple the datacenter 12 to network device(s) 108 and other external devices for data exchange and connectivity. Examples of a communication network 14 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. Each type of network offers specific advantages tailored to different operational requirements. For instance, an IP network or Ethernet network may provide widespread compatibility and ease of integration, supporting various protocols and applications across the datacenter 12 and the network device(s) 16 (and/or external devices). An InfiniBand network may offer high throughput and low latency, ideal for HPC environments where rapid data transfer and minimal delay are required. Fibre Channel networks may be employed for their robust performance in storage area networks (SANs), ensuring fast and reliable access to storage resources. Cellular and wireless communication networks may be used to extend connectivity to remote and/or mobile devices for increased flexibility and/or accessibility. The ability of the communication network 14 to incorporate multiple network types and/or configurations allows the datacenter 12 to adapt to diverse application needs, from general data communication to specialized HPC tasks.

The network device(s) 16 may include a variety of computing devices capable of transmitting and receiving signals over the communication network 14. The network device(s) 16 may range from personal computing devices to complex server configurations. Examples include Personal Computers (PCs), laptops, tablets, smartphones, servers, and/or the like. The network device(s) 16 may facilitate user interactions with the datacenter 12, allowing for data input, retrieval, and/or processing from remote locations. In addition to individual computing devices, the network device(s) 16 may also include collections of servers and/or additional datacenters. For instance, these could be other datacenters similar to or the same as datacenter 12. Such an interconnection may allow for the formation of a distributed computing environment for improved redundancy, load balancing, and/or disaster recovery capabilities. By linking multiple datacenters, the network architecture 10 can leverage geographically dispersed resources, optimizing performance and/or ensuring high availability.

As described herein, the datacenter 12 and/or the network device(s) 16 may include storage devices and processing circuitry for executing computing tasks, such as controlling the flow of data internally and over the communication network 14. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, DPUs, QPUs, PPUs, microprocessors, Field-Programmable Gate Arrays (FPGAs), collections of logic gates or transistors, resistors, capacitors, inductors, and/or diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, it should be appreciated that the datacenter 12 and network device(s) 16 may include one or more communication interfaces for facilitating wired and/or wireless communication between one another and other unillustrated elements of the network architecture 10. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 10.

Furthermore, it should be understood that the network architecture 10 may include additional components and functionalities within the scope of the present disclosure. These components may comprise, without limitation, additional processing units, specialized accelerators (such as Tensor Processing Units or TPUs), enhanced security modules, and/or redundant power supplies. The inclusion of these elements is intended to ensure that the network architecture 10 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 10.

### Example Network Topology of the Network Architecture

FIG. 10 illustrates an example datacenter network topology 20, in accordance with an embodiment of the disclosure. As shown in FIG. 10, the example datacenter network topology 20 is exemplified using a fat tree topology. However, it is to be understood that the fat tree topology merely serves as a representative model to describe the datacenter network architecture. Other network topologies may also be contemplated within the scope of the disclosure. Examples of such alternative topologies include, but are not limited to, Slim Fly topology, which is designed to reduce the number of hops and cable lengths between nodes; Dragonfly topology, which aims to enhance network scalability and reduce latency through a hierarchical group of interconnected switches; and other hierarchical or non-hierarchical topologies that may be optimized for specific performance, scalability, and/or cost considerations. The principles and innovations disclosed herein can be applied to these and other network topologies to achieve similar advantages and benefits. Any modifications, variations, or adaptations of the network topologies that fall within the spirit and scope of the present disclosure are considered to be encompassed by this disclosure.

As shown in FIG. 10, the example datacenter network topology 20 may include three distinct layers: an edge layer 22, an aggregation layer 24, and a core layer 26. The edge layer 22, located at the bottom of the hierarchy, may incorporate Top-of-Rack (ToR) switches ELS₁, ELS₂, . . . , ELSₙ. The edge layer 22 may serve as the initial point of aggregation for traffic originating from the servers operatively coupled to the ToR switches ELS₁, ELS₂, . . . , ELSₙ in the edge layer 22. Each ToR switch may connect multiple servers within a rack, consolidating data traffic from those servers and forwarding it to the higher layers of the network. The edge layer 22 may be responsible for handling east-west traffic within the datacenter, facilitating efficient data exchange between servers located in different racks.

The aggregation layer 24 may be positioned above the edge layer 22 and may further consolidate traffic from multiple ToR switches. In one embodiment, the aggregation layer 24 may include switches ALS₁, ALS₂, . . . , ALSₒ that are configured to receive data traffic from the ToR switches in the edge layer 22. These aggregation switches may aggregate traffic and manage load balancing, ensuring that data flows efficiently between the edge layer 22 and the core layer 26. The aggregation layer 24 may also provide redundancy and fault tolerance, allowing data traffic to be rerouted in case of failures in the network.

At the top of the hierarchy, the core layer 26 may include high-speed switches CLS₁, CLS₂, . . . , CLSₘ. The core layer 26 may serve as the backbone of the datacenter network, providing high-speed interconnectivity between the switches of the aggregation layer 24 and ensuring data can traverse the network quickly and efficiently. The core layer 26 may be responsible for managing north-south traffic, enabling communication between the datacenter and external networks or between different datacenters. In some embodiments, the core layer 26 may support multiple data paths and implement advanced routing protocols to optimize data transmission across long distances or between different geographic locations.

The datacenter network topology 20 may be configured to support high bandwidth and low-latency communication, enabling efficient handling of large-scale data transfers and computational tasks. By implementing a hierarchical network structure, with the edge layer 22, aggregation layer 24, and core layer 26, the datacenter network topology 20 may facilitate scalable and resilient network performance, accommodating the increasing demands of modern high-performance computing and cloud-based applications. As described herein, various network topologies, such as fat tree, Slim Fly, or Dragonfly topologies, may be implemented within this layered structure, depending on the specific requirements of the datacenter infrastructure.

Furthermore, the interconnections between the layers (e.g., the edge layer 22, aggregation layer 24, and core layer 26) may be established using high-speed networking technologies such as Ethernet®, InfiniBand®, or optical fiber, depending on the required data transfer rates and latency considerations. Each layer in the datacenter network topology 20 may be optimized to handle specific types of traffic and ensure smooth communication across the network, providing flexibility and scalability in various operational scenarios.

The switches (e.g., CLS₁₋ₘ, ALS₁₋ₒ, and ELS₁₋ₙ) within each layer may be 1U switches, where “1U” refers to the industry-standard size for rack-mounted switches and servers. The switches may be electrical switches, optical switches, hybrid electro-optical switches, or any combination thereof. Each type of switch may include suitable hardware and/or software for routing signals within its respective domain.

An electrical switch may be configured to receive and route optical signals by first converting them into electrical signals. The conversion process may involve receivers that include components such as a transimpedance amplifier (TIA), a photodetector, and a controller, all of which work together to convert incoming optical signals into electrical signals. Once converted, the electrical signals may be routed through the internal circuitry of the switch. The electrical switch may also include transmitters that convert the routed electrical signals back into optical signals for transmission to another switch (either optical or electrical) within the network. These transmitters may include a light source, a modulator, and a controller to manage the modulator and light source. In some embodiments, the receiver and transmitter functions may be combined into a single transceiver to streamline signal conversion and transmission.

An optical switch, by contrast, routes optical signals directly without converting them into electrical form. The optical switch may include optical receivers, such as photodetectors and wavelength-division multiplexing (WDM) demultiplexers, to receive and manage incoming optical signals. These signals may then be routed through internal optical switching components, such as micro-electromechanical systems (MEMS) mirrors, waveguides, or optical cross-connects, which guide the signals to their appropriate output paths. The optical switch may further include optical transmitters, such as laser diodes and modulators, which transmit the routed optical signals to the next switch in the network.

The interconnections 28 between the switches within the network topology may be implemented using optical fibers and/or traditional electrical cables, depending on the specific requirements of the system. The interconnections 28 may serve as communication lanes, which may be constructed of dedicated differential cable pairs and/or fiber optics, with each option tailored to meet the performance demands of data transmission.

Dedicated differential cable pairs used in these interconnections may be composed of a variety of cable media, including copper, aluminum, gold, silver, nickel, or composite materials such as copper-clad aluminum, copper-clad steel, or bimetallic conductors. These materials may be selected based on their electrical conductivity and durability, ensuring reliable and efficient data transmission. In some implementations, a four-lane network may be employed, where each lane consists of its own dedicated copper cable, thereby providing isolated physical paths for each communication lane of a deserialized data stream, which helps maintain signal integrity and reduce crosstalk between the lanes.

Alternatively, fiber optic cables may be employed for the interconnections. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates. Various optical networking technologies, such as Time Division Multiplexing (TDM), Frequency Division Multiplexing (FDM), or Wavelength Division Multiplexing (WDM), can be used to transmit multiple optical signals (e.g., data signals or data streams) over a single optical fiber within an optical link with little to no optical signal interference. These optical networking technologies may be used to improve bandwidth efficiency and reduce the amount of infrastructure needed for data communication. In TDM, multiple optical signals can be transmitted over a single optical fiber by assigning each optical signal a respective time slot and transmitting an optical signal during its assigned time slot; in FDM, multiple optical signals can be transmitted over a single optical fiber by assigning each optical signal a respective frequency band; and in WDM, multiple optical signals having different wavelengths are combined into a single optical signal and transmitted over a single optical fiber.

### Example Multichip-Module (MCM Assembly

FIG. 11 is a block diagram that schematically illustrates a co-packaged networking device 1000, in accordance with an embodiment that is disclosed herein. The different chips that constitute a co-packaged networking device are assembled on a single substrate in what is typically called the MCM assembly 1012. The MCM assembly 1012 can include a switching circuitry 1016 surrounded by peripheral or satellite chips 1020. In some embodiments, the switching circuitry 1016 and surrounding satellite chips 1020 are all mounted on a common substrate, although such a configuration is not required. The MCM assembly 1012 may be provided in a larger housing of the networking device 1000, positioned behind the front panel 1004. The switching circuitry 1016 may include one or more core digital Application Specific Integrated Circuits (ASICs), CPUs, GPUs, microprocessors, FPGAs, combinations thereof, and the like. The switching circuitry 1016 may include a number of input ports and/or output ports 1028. The Input/Output (I/O) ports 1024 may include electrical ports and/or optical ports. Additionally, the switching circuitry 1016 may include a combination of electrical blocks and optical blocks. The electrical blocks of the switching circuitry 1016 may include a number of electrical switches that are configured to route signals in an electrical domain. The optical blocks of the switching circuitry 1016 may include a number of optical components that are configured to generate, detect and route signals in an optical domain. The MCM assembly 1012, in some embodiments, may concern or include multiple satellite chips 1020 that are assembled on the same substrate as the switching circuitry 1016. In some embodiments, a configuration of the optical block(s) and a configuration of the electrical block(s) depends (e.g., is based on) on the number of optical ports in the I/O ports 1024.

As discussed above, optical I/Os 1008, which may also be referred to as optical connectors, are placed at the front panel 1004. As mentioned above, connectivity between the MCM assembly 1012 and optical I/Os 1008 may be transferred to the front panel 1004 through optical fibers. This connection may be made directly with an optical I/O 1024 of the switching circuitry or may be made with one or more of the satellite chips 1020. The connection is often made with one or more of the satellite chips 1020 because the satellite chips 1020 may include the electro-optic converters and, possibly, the SERDES to natively support the connection. The satellite chips 1020 may include one or more of a DSP processor, driver, trans-impedance amplifier, laser, modulator, photodiode, serializer-deserializer, or the like.

Some embodiments of the present disclosure are directed to a multi-chip module (MCM) with a centrally positioned main die and a plurality of peripherally positioned MCM sockets configured to mechanically receive and electrically connect mezzanine packages, which may include co-packaged optics (CPO) packages and co-packaged copper (CPC) packages. Each mezzanine package may include a package substrate including a connector portion that is configured to engage the MCM socket and a main portion extending beyond the periphery of the MCM substrate. The main portion of the mezzanine package may be configured to receive optical devices and/or integrated circuits, such as via mezzanine sockets, to allow connections to be made between the optical devices and/or integrated circuits/RF copper cable connectors and the main die of the MCM. Due to the extension of the mezzanine package beyond the periphery of the MCM substrate, the physical size of the MCM substrate may remain small to reduce cost and avoid the previously discussed production challenges, while allowing connections to a number of optical devices and integrated circuits via the mezzanine packages, which occupy the relatively inexpensive space around the periphery of the MCM substrate. As used herein, the terms “co-packaged optic” (or “CPO”) and “co-packaged copper” (or “CPC”) may refer to an advanced heterogeneous integration of either optics and silicon or copper and silicon, in which either integration may be implemented on a single packaged substrate. The CPO may utilize pluggable optical modules that include an optical engine (OE) to convert optical signals to electrical signals and electrical signals to optical signals. The CPO may further be comprised of an optical component on a photonics die and an electrical component on an electrical die.

As used herein, a ball grid array (BGA) may be a type of surface-mount packaging used for integrated circuits. BGA packages use an array of metallic conductor balls arranged in a grid to permanently mount devices such as microprocessors on a PCB. The metallic conductor balls may then undergo the reflow process described above, wherein the metallic conductor balls may be preheated, then melted to bond the IC to a substrate to form an IC package.

As used herein, a flip chip (FC) may refer to a method for interconnecting dies, such as semiconductor devices, IC chips, integrated passive devices, and microelectromechanical systems (MEMS), to external circuitry with solder bumps that have been deposited onto chip pads. The solder bumps may be deposited onto chip pads on the top side of the wafer during final wafer processing. The chip may be mounted to external circuitry (such as a circuit board or another chip or wafer) by “flipping” the chip, such that the chip's top side faces down and is positioned to allow the pads of the chip to align with matching pads on the external circuit. Solder is reflowed to complete the interconnect.

An integrated photonics device as used herein refers to a device comprising a plurality of photonic components fabricated and co-located on a common substrate to guide, manipulate, generate, or detect optical signals. Integrated photonics devices are designed to perform high-speed, low-latency signal processing or communication tasks with reduced power consumption and improved signal integrity, often serving applications in data communications, telecommunications, sensing, quantum technologies, or biomedical systems.

The device typically includes waveguides, modulators, couplers, filters, detectors, and one or more integrated light sources, such as lasers, forming a compact, monolithically or heterogeneously integrated photonic circuit. The substrate may be formed from materials suitable for photonic integration, including but not limited to silicon, silicon nitride, indium phosphide, or other compound semiconductors. In some embodiments, the integrated laser is formed on the same substrate (monolithic integration), while in other embodiments, the laser is fabricated separately and bonded or coupled to the photonic circuit (hybrid or heterogeneous integration). The integrated laser may be a distributed feedback (DFB) laser, distributed Bragg reflector (DBR) laser, external cavity laser, or other suitable type depending on the target application.

The integrated laser provides an on-chip optical source, enabling self-contained optical transmission, modulation, and routing without reliance on external light sources. This allows for reduced system complexity, lower coupling loss, and improved scalability in densely packed photonic systems.

An integrated photonics device may further include electrical drivers and control circuitry co-packaged with the photonic components, forming a photonic-electronic integrated system. The design supports high-speed, low-power optical communication and signal processing across a range of applications, including data center interconnects, high-performance computing, telecommunications, optical sensing, and integrated LiDAR systems.

Packaging and coupling interfaces may be provided to facilitate optical I/O to and from the chip, such as edge couplers, grating couplers, or fiber array terminations. Thermal management structures may also be included to maintain performance stability of the integrated laser and surrounding photonic components. In certain embodiments, the photonic device may interface with electrical components, either on the same chip or through an adjacent electronic integrated circuit (EIC), to form a photonic-electronic co-integrated system. Packaging considerations may include fiber coupling interfaces, thermal management structures, and alignment features to ensure stable operation.

### Example Method for Providing Optical Communication via a Silicon Photonic Collimator

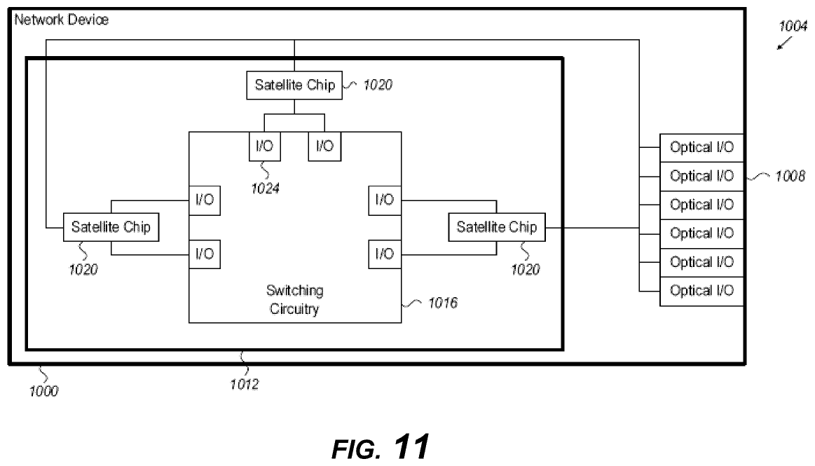

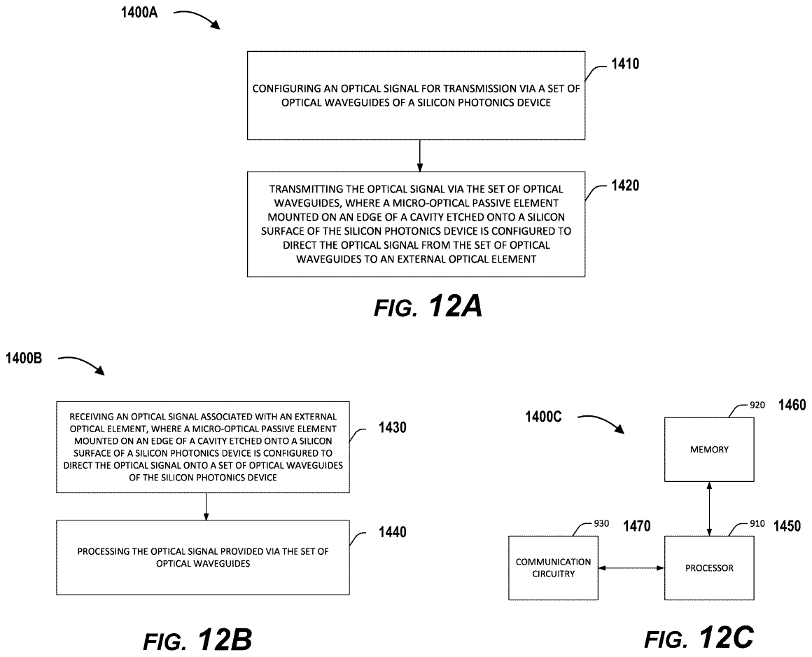

FIG. 12A is a flowchart illustrating an example method 1400A for providing optical communications via a silicon photonics collimator in accordance with one or more embodiments of the present disclosure. It will be understood that each block of the flowcharts, and combinations of blocks in the flowcharts, may be implemented by various means. In some example embodiments, certain ones of the operations herein may be modified or further amplified as described below. Moreover, in some embodiments additional optional operations may also be included. It should be appreciated that each of the modifications, optional additions, or amplifications described herein may be included with the operations herein either alone or in combination with any others among the features described herein. The operations illustrated in FIG. 12A may, for example, be performed by an example computing system 1400C (shown in FIG. 12C). In certain embodiments, the computing system 1400C can be embedded in an optical module (e.g., a silicon photonics transceiver module). In some embodiments, the computing system 1400C is a firmware computing system embedded in an optical module (e.g., a silicon photonics transceiver module). In one or more embodiments, at operation 1410, the computing system 1400C configures an optical signal for transmission via a set of optical waveguides of a silicon photonics device. In one or more embodiments, at operation 1420, the computing system 1400C transmits the optical signal via the set of optical waveguides, where a micro-optical passive element mounted on an edge of a cavity etched onto a silicon surface of the silicon photonics device is configured to direct the optical signal from the set of optical waveguides to an external optical element.

FIG. 12B is a flowchart illustrating an example method 1400B for providing optical communications via a silicon photonics collimator in accordance with one or more embodiments of the present disclosure. It will be understood that each block of the flowcharts, and combinations of blocks in the flowcharts, may be implemented by various means. In some example embodiments, certain ones of the operations herein may be modified or further amplified as described below. Moreover, in some embodiments additional optional operations may also be included. It should be appreciated that each of the modifications, optional additions, or amplifications described herein may be included with the operations herein either alone or in combination with any others among the features described herein. The operations illustrated in FIG. 12B may, for example, be performed by an example computing system 1400C (shown in FIG. 12C). In certain embodiments, the computing system 1400C can be embedded in an optical module (e.g., a silicon photonics transceiver module). In some embodiments, the computing system 1400C is a firmware computing system embedded in an optical module (e.g., a silicon photonics transceiver module). In one or more embodiments, at operation 1430, the computing system 1400C receives an optical signal associated with an external optical element, where a micro-optical passive element mounted on an edge of a cavity etched onto a silicon surface of a silicon photonics device is configured to direct the optical signal onto a set of optical waveguides of the silicon photonics device. In one or more embodiments, at operation 1440, the computing system 1400C processes the optical signal provided via the set of optical waveguides.

FIG. 12C illustrates the computing system 1400C that may be embedded in an optical module (e.g., a silicon photonics transceiver module). In some cases, the computing system 1400C may be a firmware computing system communicatively coupled with, and configured to control, one or more circuit modules associated with an optical module (e.g., a silicon photonics transceiver module). For example, the computing system 1400C may be a firmware computing system and/or a controller computing system communicatively coupled with one or more circuit modules, such as an optical module (e.g., a silicon photonics transceiver module). The computing system 1400C may include or otherwise be in communication with a processor 1450, a memory circuitry 1460, and communication circuitry 1470. In some embodiments, the processor 1450 (which may include multiple or co-processors or any other processing circuitry associated with the processor) may be in communication with the memory circuitry 1460. The memory circuitry 1460 may comprise non-transitory memory circuitry and may include one or more volatile and/or non-volatile memories. In some examples, the memory circuitry 1460 may be an electronic storage device (e.g., a computer readable storage medium) configured to store data that may be retrievable by the processor 1450. In some examples, the data stored in the memory 1460 may include classical communication protocol data and/or quantum communication protocol data, or the like for enabling the apparatus to carry out various functions or methods in accordance with embodiments of the present disclosure, described herein.

In some examples, the processor 1450 may be embodied in a number of different ways. For example, the processor may be embodied as one or more of various hardware processing means such as a microprocessor, a coprocessor, a digital signal processor (DSP), a controller, or a processing element with or without an accompanying DSP. The processor 1450 may also be embodied in various other processing circuitry including integrated circuits such as, for example, an FPGA (field programmable gate array), a microcontroller unit (MCU), an ASIC (application specific integrated circuit), a hardware accelerator, or a special-purpose electronic chip. Furthermore, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading. In some embodiments, the processor 1450 is a microprocessor.

In an example embodiment, the processor 1450 may be configured to execute instructions, such as computer program code or instructions, stored in the memory circuitry 1460 or otherwise accessible to the processor 1450. Alternatively or additionally, the processor 1450 may be configured to execute hard-coded functionality. As such, whether configured by hardware or software instructions, or by a combination thereof, the processor 1450 may represent a computing entity (e.g., physically embodied in circuitry) configured to perform operations according to an embodiment of the present disclosure described herein. For example, when the processor 1450 is embodied as an ASIC, FPGA, or similar, the processor may be configured as hardware for conducting the operations of an embodiment of the disclosure. Alternatively, when the processor 1450 is embodied to execute software or computer program instructions, the instructions may specifically configure the processor 1450 to perform the algorithms and/or operations described herein when the instructions are executed. However, in some cases, the processor 1450 may be a processor of a device (e.g., a mobile terminal, a fixed computing device, a semiconductor fabrication device, a robot device, etc.) specifically configured to employ an embodiment of the present disclosure by further configuration of the processor using instructions for performing the algorithms and/or operations described herein. The processor 1450 may further include a clock, an arithmetic logic unit (ALU) and logic gates configured to support operation of the processor 1450, among other things.

The computing system 1400C may optionally also include the communication circuitry 1470. The communication circuitry may be any means embodied in either hardware or a combination of hardware and software that is configured to receive and/or transmit data from/to a network and/or any other device or module in communication with the computing system 1400C. In this regard, the communication interface may include, for example, supporting hardware and/or software for enabling communications. As such, for example, the communication circuitry 1470 may include a communication modem and/or other hardware/software for supporting communication via cable, universal serial bus (USB), integrated circuit receiver, or other mechanisms.

### Example Optoelectronic Component

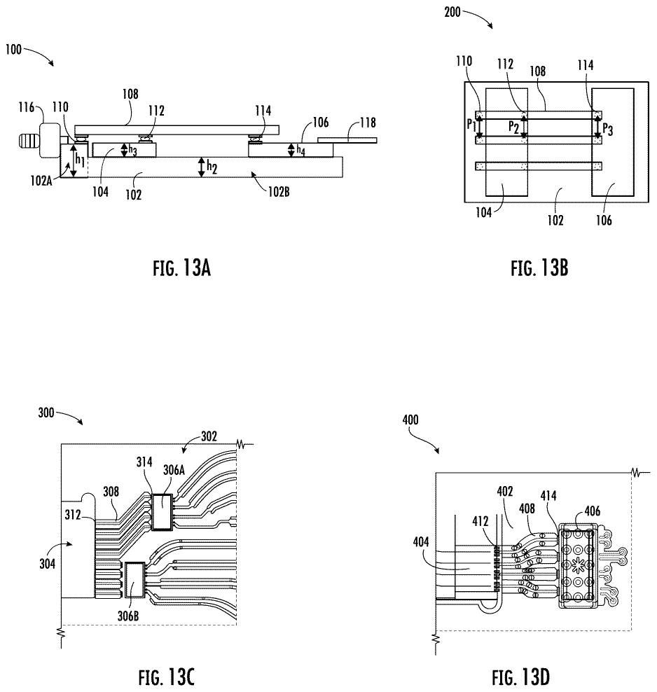

With reference to FIGS. 13A and 13B, a cross-sectional view and a top plan view, respectively, of an optoelectronic component 100 are illustrated. In some embodiments, the optoelectronic component 100 may include a substrate 102. The substrate 102, for example, may be a printed circuit board, a metal carrier, an organic carrier, and/or a ceramic carrier. In some embodiments, the height of the substrate 102 may vary. In this regard, for example, a first portion 102A of the substrate 102 may have a height h1 and a second portion 102B of the substrate 102 may have a height h2. In some embodiments, an electronic integrated circuit 104 may be supported by the substrate 102. The electronic integrated circuit 104 may be any type of electronic integrated circuit. For example, the electronic integrated circuit 104 may be a digital signal processor, a modulator driver, and/or a transimpedance amplifier. In some embodiments, there may be more than one electronic integrated circuit supported by the substrate 102. In some embodiments, the electronic integrated circuit 104 may have a height h3. In some embodiments, the optoelectronic component 100 may support more than one electronic integrated circuit. In some embodiments, a photonic integrated circuit 106 may be supported by the substrate 102. The photonic integrated circuit 106 may be any type of photonic integrated circuit. For example, the photonic integrated circuit 106 may be an electro-optic modulator, a photodiode, a transmitter optical sub assembly and/or a receiver optical sub assembly. In some embodiments, the photonic integrated circuit 106 may comprise graphene. In some embodiments, there may be more than one photonic integrated circuit supported by the substrate 102. In some embodiments, the photonic integrated circuit 106 may have a height h4. In some embodiments, the heights h1, h2, h3, and h4 may be different. For example, depending on the electronic integrated circuit and photonic integrated circuit used, the height h3 may be greater that the height h4, or vice versa.

In some embodiments, the optoelectronic component 100 may include one or more optical fibers 118 connected to the photonic integrated circuit 106. The one or more optical fibers 118 may be configured to connect the optoelectronic component 100 to other optical components and/or devices. In some embodiments, a port 116 may be connected to the substrate 102. The port 116 may be configured to connect the optoelectronic component 100 to other electronic components and/or devices. In some embodiments, the optoelectronic component 100 may be configured to operate at speeds greater than 25 Gb/s.

The optoelectronic component 100 may include a plurality of substrate interconnect connectors 110 disposed on the substrate 102, a plurality of electronic integrated circuit interconnect connectors 112 disposed on the electronic integrated circuit 104, and a plurality of photonic integrated circuit interconnect connectors 114 disposed on the photonic integrated circuit 106. The plurality of substrate interconnect connectors 110, the plurality of electronic integrated circuit interconnect connectors 112, and the plurality of photonic integrated circuit interconnect connectors 114 may comprise any conductive material (e.g., conductive glue and/or solder). In some embodiments, the plurality of substrate interconnect connectors 110, the plurality of electronic integrated circuit interconnect connectors 112, and the plurality of photonic integrated circuit interconnect connectors 114 may be flexible. In other words, in some embodiments, the plurality of substrate interconnect connectors 110, the plurality of electronic integrated circuit interconnect connectors 112, and the plurality of photonic integrated circuit interconnect connectors 114 may be manipulated such that each may be capable of taking various shapes. In some embodiments, the plurality of substrate interconnect connectors 110 may have a pitch p1, the plurality of electronic integrated circuit interconnect connectors 112 may have a pitch p2, and the plurality of photonic integrated circuit interconnect connectors 114 may have a pitch p3. The pitch may refer to the distance between each of the plurality of interconnect connectors. In some embodiments, the pitch p1, pitch p2, pitch p3, may be different. For example, the pitch p2 of the plurality of electronic integrated circuit interconnect connectors 112 may be 1.25 mm while the pitch p3 of the plurality of photonic integrated circuits may be 1.5 mm.

In some embodiments, the optoelectronic component 100 may include a first plurality of cable connectors 108. In some embodiments, each of the first plurality of cable connectors 108 may be connected to and in communication with the substrate 102, the electronic integrated circuit 104, and the photonic integrated circuit 106 via respective interconnect connectors. In other words, the first plurality of cable connectors 108 may be connected to and in communication with the substrate 102 via the plurality of substrate interconnect connectors 110, the electronic integrated circuit 104 via the plurality of electronic integrated circuit interconnect connectors 112, and the photonic integrated circuit 106 via the plurality of photonic integrated circuit interconnect connectors 114. As such, the first plurality of cable connectors 108 may be used to facilitate communication between the substrate 102, the electronic integrated circuit 104, and the photonic integrated circuit 106.

In some embodiments, the first plurality of cable connectors 108 may define a first layout. In some embodiments, the first layout may define the overall connectivity of the optoelectronic component 100. For example, with reference to FIG. 13C, the connectivity defined by the first layout in the illustrated example is such that an electronic integrated circuit 304 is connected to a first photonic integrated circuit 306A and a second photonic integrated circuit 306B via cable connectors 308. In some embodiments, the first plurality of cable connectors 108 may be interchangeable with other pluralities of cable connectors that define different layouts. The different layouts may alter the overall connectivity of the optoelectronic component 100. For example, the first plurality of cable connectors 108 may be interchangeable with a second plurality of cable connectors that define a second layout which modifies the overall connectivity of the optoelectronic component 100. In this way, the optoelectronic component 100 may be easily modified to obtain desired capabilities by interchanging cable connectors.

In some embodiments, the first plurality of cable connectors 108 may be flexible. This may help ensure that the first plurality of cable connectors 108 may be used with a variety of substrates, electronic integrated circuits, and photonic integrated circuits. For example, the substrate, electronic integrated circuit, and/or photonic integrated circuit may be from different manufactures, may be a different type of integrated circuit or substrate, and/or may have different capabilities. For example, the substrate 102, electronic integrated circuit 104, and the photonic integrated circuit 106 may have different heights (e.g., height h3 of the electronic integrated circuit 104 may be greater than height h4 of the photonic integrated circuit 106). The flexibility of the first plurality of cable connectors 108 enables the first plurality of cable connectors 108 to bend as needed, such that components of the optoelectronic component 100 with different heights may be accommodated and connections may be made without any modifications to the configuration of the optoelectronic component 100 itself. Additionally, the flexibility of the first plurality of cable connectors 108 may enable the first plurality of cable connectors 108 to be used with a variety of substrates, electronic integrated circuits, and photonic integrated circuits that have interconnect connectors with different pitches. For example, if the pitch p2 of the plurality of electronic integrated circuit interconnect connectors 112 is less than the pitch p3 of the plurality of photonic integrated circuit interconnect connectors 114, the first plurality of cable connectors 108 may bend to account for the differences in pitch and connect the electronic integrated circuit 104 to the photonic integrated circuit 106.

With reference to FIG. 13C a portion of an example optoelectronic component 300 is illustrated. For example, the example optoelectronic component 300 may be part of a 1.6 Tb/s demonstrator. The example optoelectronic component 300 includes a substrate 302, an electronic integrated circuit 304 supported by the substrate 302, a first photonic integrated circuit 306A supported by the substrate 302, and a second photonic integrated circuit 306B supported by the substrate 302. The example optoelectronic component 300 may include a plurality of electronic integrated circuit interconnect connectors 312 disposed on the electronic integrated circuit 304 and a plurality of photonic integrated circuit interconnect connectors 314 disposed on the first photonic integrated circuit 306A and the second photonic integrated circuit 306B. The electronic integrated circuit 304 may be connected to and in communication with the first photonic integrated circuit 306A and the second photonic integrated circuit 306B via a plurality of cable connectors 308. In the example optoelectronic component 300, the electronic integrated circuit 304 and the first photonic integrated circuit 306A are situated on the substrate 302 such that the plurality of electronic integrated circuit interconnect connectors 312 and the plurality of photonic integrated circuit interconnect connectors 314 disposed on the first photonic integrated circuit 306A are not aligned with each other (e.g., one is not disposed directly opposite to the other). In such a situation, the flexibility of the plurality of cable connectors 308 facilitating communication between the electronic integrated circuit 304 and the first photonic integrated circuit 306A may allow the electronic integrated circuit 304 and the first photonic integrated circuit 306A to be connected through manipulation of the cable connectors to accommodate the misaligned locations.

With reference to FIG. 13D, another example optoelectronic component 400 is illustrated. For example, the example optoelectronic component 400 may be part of an octal small form factor pluggable (OSFP) transceiver. The example optoelectronic component 400 includes a substrate 402, an electronic integrated circuit 404 supported by the substrate 402, and a photonic integrated circuit 406 supported by the substrate 402. The example optoelectronic component 400 may include a plurality of electronic integrated circuit interconnect connectors 412 disposed on the electronic integrated circuit 404 and a plurality of photonic integrated circuit interconnect connectors 414 disposed on the photonic integrated circuit 406. The electronic integrated circuit 404 may be connected to and in communication with the photonic integrated circuit 406 via a plurality of cable connectors 408. In the example optoelectronic component 400, the pitch of the plurality of the electronic integrated circuit interconnect connectors 412 and the plurality of photonic integrated circuit interconnect connectors 414 is different. In this case, the flexibility of the plurality of cable connectors 408 facilitating communication between the electronic integrated circuit 404 and the photonic integrated circuit 406 may be such that the electronic integrated circuit 404 and the photonic integrated circuit 406 can be connected despite the differences in pitch, such as through bending or other reshaping of the cable connectors to accommodate the differences.

When the light-transmitting medium is silicon, a suitable insulator includes, but is not limited to, silica and a suitable substrate includes a silicon substrate. A silicon-on-insulator wafer is a suitable platform for an optical device having a silicon light-transmitting medium positioned over a base having a silica insulator and a silicon substrate.

The device includes one or more waveguides that carry light signals to and/or from optical components. Examples of optical components that can be included on the device include, but are not limited to, one or more components selected from a group consisting of facets through which light signals can enter and/or exit a waveguide, entry/exit ports through which light signals can enter and/or exit a waveguide from above or below the device, multiplexers for combining multiple light signals onto a single waveguide, demultiplexers for separating multiple light signals such that different light signals are received on different waveguides, optical couplers, optical switches, lasers that act as a source of a light signal, amplifiers for amplifying the intensity of a light signal, attenuators for attenuating the intensity of a light signal, modulators for modulating a signal onto a light signal, modulators that convert a light signal to an electrical signal, and vias that provide an optical pathway for a light signal traveling through the device from the bottom side of the device to the top side of the device. Additionally, the device can optionally, include electrical components. For instance, the device can include electrical connections for applying a potential or current to a waveguide and/or for controlling other components on the optical device.

While certain exemplary embodiments have been described and shown in the accompanying drawings, it is to be understood that such embodiments are merely illustrative of and not restrictive on the broad disclosure, and that this disclosure is not limited to the specific constructions and arrangements shown and described, since various other changes, combinations, omissions, modifications, and substitutions, in addition to those set forth in the above paragraphs, are possible. Those skilled in the art will appreciate that various adaptations, modifications, and combinations of the just described embodiments may be configured without departing from the scope and spirit of the disclosure. For example, devices, modules, components, and/or elements shown in the figures are not necessarily drawn to scale and may vary from that shown without departing from the scope and spirit of the disclosure. Therefore, it is to be understood that the disclosure may be practiced other than as specifically described herein.

Some embodiments of the present disclosure include a method of manufacturing a detachable connector for a co-packaged optics (CPO) device, the method comprising aligning a planar body of a mounting element with respect to a photonics integrated circuit (PIC), the mounting element comprising a first kinematic interface, aligning an optical window of the mounting element with respect to the PIC based on receiving feedback from one or more test fibers, bonding the mounting element to the PIC, aligning a fiber array unit (FAU) with respect to an attachment element, the attachment element comprising a second kinematic interface configured for repeated detachment and attachment with substantially identical alignment between the first kinematic interface and the second kinematic interface within a predetermined sub-micron tolerance, and bonding the FAU to the attachment element.

Some embodiments of the present disclosure are directed to an attachment element comprising a first kinematic interface, the first kinematic interface comprising at least one rough alignment element and a plurality of fine alignment elements, where the attachment element is configured to be coupled to a fiber array unit (FAU), the first kinematic interface is configured to be detachably coupled to a second kinematic interface of a mounting element, the mounting element being coupled to a photonics integrated circuit (PIC), and, in an instance in which the mounting element is attached to the PIC and the attachment element is attached to the FAU, the attachment element is configured to be detachably coupled to the mounting element such that each fiber of the FAU is aligned with a corresponding optical aperture of the PIC. The rough alignment element may comprise a column configured to be engaged by a cavity of the mounting element, and/or the rough alignment element may comprise a cavity configured to receive a column extending from the mounting element. The plurality of fine alignment elements may comprise a plurality of spheres, each sphere being configured to be received by a groove of the mounting element, and/or the plurality of fine alignment elements may comprise a plurality of grooves, each groove being configured to receive a sphere of the mounting element. Each groove may comprise a friction-reducing coating. The attachment element may further comprise a bonding surface configured to couple with a corresponding surface of the FAU, where the bonding surface is positioned at an angle with respect to the first kinematic interface. The angle may be a predetermined angle selected to minimize a working distance between an end of each fiber of the FAU and a corresponding optical aperture of the PIC.

Some embodiments of the present disclosure include a method of manufacturing a detachable connector having a kinematic mount mechanism, as well as a positioning tool used to manufacture the kinematic mount mechanism. The method and positioning tool are described in greater detail in U.S. Patent Application No. [ ], titled “Devices and Methods for Manufacturing Detachable Co-Packaged Connectors,” filed concurrently herewith and incorporated by reference herein. Furthermore, some embodiments of the presented disclosure include a group of detachable connectors configured to attach and detach from an electronic module in a ganged fashion, as described in greater detail in U.S. Patent Application No. [ ], titled “Devices and Methods for Detachable Coupling of Co-Packaged Optical Connectors,” filed concurrently herewith and incorporated by reference herein.

What is claimed is:

1. A detachable connector comprising:
a kinematic mount, wherein the kinematic mount comprises a first kinematic interface configured to engage a corresponding kinematic interface of a co-packaged optics (CPO) device,
wherein the kinematic mount is configured for repeated detachment and attachment with substantially identical alignment between the detachable connector and the CPO device within a predetermined sub-micron tolerance, and
wherein, in an attached state, the kinematic mount is configured to provide an optical transmission path between the CPO device and the detachable connector, wherein a transmission loss along the optical transmission path remains within a predetermined threshold tolerance.

2. The detachable connector of claim 1, wherein the first kinematic interface comprises a plurality of alignment spheres and wherein the second kinematic interface comprises a plurality of alignment grooves configured to, in the attached state, engage a corresponding alignment sphere of the plurality of alignment spheres.

3. The detachable connector of claim 2, wherein the plurality of alignment grooves comprises three alignment grooves and wherein the plurality of alignment spheres comprises three alignment spheres.

4. The detachable connector of claim 1, wherein the kinematic mount further comprises at least one rough alignment cavity configured to, in the attached state, receive at least one corresponding rough alignment element.

5. The detachable connector of claim 4, wherein the at least one rough alignment cavity is configured to self-align with the at least one corresponding first rough alignment element by:
receiving the at least one corresponding rough alignment element via a first portion of the rough alignment cavity having a first diameter; and
allowing the at least one corresponding rough alignment element to slide along an inner surface of the rough alignment cavity toward a second portion of the rough alignment cavity, the second portion having a second diameter narrower than the first diameter.

6. A system comprising:
a mounting element configured to be attached to a photonic integrated circuit (PIC), wherein the mounting element comprises:
a planar body defining an optical window, and
a first kinematic interface supported by the planar body, the first kinematic interface comprising at least one first rough alignment element and a plurality of first fine alignment elements; and
an attachment element configured to be attached to a fiber array unit (FAU), wherein the attachment element comprises a second kinematic interface, the second kinematic interface comprising:
at least one second rough alignment element configured to engage the at least one first rough alignment element of the mounting element, and
a plurality of second fine alignment elements, wherein each second fine alignment element is configured to engage a corresponding first fine alignment element of the plurality of first fine alignment elements,
wherein, in an instance in which the mounting element is attached to the PIC and the attachment element is attached to the FAU, the attachment element is configured to be detachably coupled to the mounting element such that each fiber of the FAU is aligned with a corresponding optical aperture of the PIC.

7. The system of claim 6, wherein one of the at least one first rough alignment element or the at least one second rough alignment element comprises a column, and wherein the other of the at least one first rough alignment element or the at least one second rough alignment element comprises a cavity configured to receive the column.

8. The system of claim 6, wherein one of the plurality of first fine alignment elements or the plurality of second fine alignment elements comprises a sphere, and wherein the other of the plurality of first fine alignment elements or the plurality of second fine alignment elements comprises a groove configured to receive the sphere.

9. The system of claim 8, wherein the groove comprises a friction-reducing coating.

10. The system of claim 6, wherein each second fine alignment element comprises a sphere, and wherein each first fine alignment element comprises a groove configured to receive the sphere.

11. The system of claim 10, wherein a bottom surface of the attachment element comprises at least one concavity, wherein the sphere is adhered within the concavity to form the first fine alignment element.

12. The system of claim 10, wherein a bottom surface of the attachment element comprises at least one concavity, wherein the sphere is integrally formed within the concavity to form the first fine alignment element.

13. The system of claim 10, wherein the attachment element comprises three first fine alignment elements.

14. The system of claim 13, wherein the first fine alignment elements are arranged on the attachment element in a triangular configuration.

15. The system of claim 6, wherein the attachment element further comprises a bonding surface configured to couple with a corresponding surface of the FAU, wherein the bonding surface is positioned at an angle with respect to the second kinematic interface.

16. The system of claim 15, wherein the angle is a predetermined angle selected to minimize a working distance between an end of each fiber of the FAU and a corresponding optical aperture of the PIC.

17. A mounting element comprising:
a planar body defining an optical window, and
a first kinematic interface on a first surface of the planar body, the first kinematic interface comprising at least one rough alignment element and a plurality of fine alignment elements;
wherein a second surface of the planar body is configured to be attached to a photonic integrated circuit (PIC);
wherein the first kinematic interface is configured to be detachably coupled to a second kinematic interface of an attachment element, the attachment element being attached to a fiber array unit (FAU); and
wherein, in an instance in which the mounting element is attached to the PIC and the attachment element is attached to the FAU, the mounting element is configured to be detachably coupled to the attachment element such that each fiber of the FAU is aligned with a corresponding optical aperture of the PIC.

18. The mounting element of claim 17, wherein the plurality of fine alignment elements comprises three fine alignment elements arranged on the first kinematic interface in a triangular configuration.

19. The mounting element of claim 17, wherein the plurality of fine alignment elements comprises a plurality of grooves, each groove being configured to receive a sphere of the second kinematic interface.

20. The mounting element of claim 19, wherein each groove comprises a friction-reducing coating.
